(19) United States
(12) Patent Application Publication
(10) Pub. No.: US 2008/0011552 A1
(43) Pub. Date: Jan. 17, 2008

(54) Gravity powered rotational machine and method

(76) Inventor: Stephen Raoul La Perle, Bakersfield, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/732,255

(22) Filed: Apr. 2, 2007

Related U.S. Application Data
(60) Provisional application No. 60/787,894, filed on Mar. 31, 2006.

(51) Int. Cl. F03G 3/00

(52) U.S. Cl. 185/27

(57) ABSTRACT

A gravity powered rotational machine for rotating an output shaft to power a generator, pump or the like. The machine comprises a frame mounted pivot bar, a plurality of first swingarms rotatably attached to a center section of the pivot bar, a weight member slidably mounted on the first swingarms, a stationary railing defining a path around the center section, a rotational structure rotatably mounted on end sections of the pivot bar, second swingarms interconnecting the rotational structure and the first swingarms, and a driving mechanism interconnecting the rotational structure and output shaft. The center section of the pivot bar is off-set from its end sections. The stationary railing guides the first swingarms around the center section and directs the weight members inwardly and outwardly on the first swingarms while they group in a drop zone and spread in a lift zone of the path to rotate the output shaft.

### CROSS-REFERENCE TO RELATED APPLICATIONS

This application claims the benefit of U.S. Provisional Patent Application No. 60/787,894 filed on Mar. 31, 2006.

### BACKGROUND OF THE INVENTION

A. Field of the Invention

The field of the present invention relates generally to machines and methods for producing rotational torque through an output shaft. More particularly, the present invention relates to such machines that utilize gravitational force to impart the rotational torque on the output shaft. Even more particularly, the present invention relates to such gravity powered machines having weights which move longitudinally along each of a plurality of arms as they swing around a support shaft to rotate a flywheel that turns the output shaft.

B. Background

Motors and other machines for converting a source of input energy to an output in the form of rotational torque that is delivered through an output shaft have been available for many years. The rotational torque at the output shaft is commonly utilized to produce electricity via a generator, power a pump, grinding wheel or other machine, turn a wheel, or operate other devices. The input energy for such machines has been provided by people, animals, moving water, gravity, blowing wind, fossil fuels, nuclear materials and a variety of other sources. Over the years, there has been a desire to have machines which utilize energy from readily available, clean and renewable sources. Such machines include water wheels and windmills. Generally, such machines are configured to result in a weight or force differential, provided by the weight of the water or force of the wind, on opposite sides of the machine's wheel or fan blades in order to rotate a shaft fixedly connected to the wheel or fan blades. The ideal configuration for such machines is to have as much of a weight or force imbalance as possible on the opposite sides of the wheel or fan blades so that the machine will generate the maximum amount of rotational torque at the output shaft. The components of these machines are shaped and configured to achieve this result.

As an example, one well known type of water wheel is configured with a plurality of buckets or other water receiving containers at or near the outer perimeter of a wheel that is attached to a center axle or shaft which rotates with the rotation of the wheel. The typical bucket-type water wheel is positioned at a source of moving water such that water flows into buckets on one side of the wheel near the top of the wheel's rotation. The water wheel has a mechanism to empty the buckets at or near the bottom of the wheel's rotation to provide, ideally, full buckets on one side of the wheel and empty buckets on the opposite side of the wheel. The weight imbalance resulting from the full/empty buckets creates a downward gravitational force on the full side that rotates the wheel. The rotation of the wheel rotates the shaft to produce rotational torque that may be utilized in a beneficial manner. As long as water will keep filling the buckets on one side and the mechanism keeps emptying the buckets at or near the bottom of the wheel's rotation, the wheel will keep turning to rotate the shaft. Unfortunately, problems with regard to filling the buckets at the top of the wheel's path and emptying the buckets at the bottom of the wheel's path reduce the efficiency of such water wheels. In addition, these water wheels require a steady, reliable source of moving water, which is often difficult to achieve without utilizing pumps or other devices to provide the source of water.

Another type of machine that utilizes a naturally and readily available source for the input energy is a gravity motor and the like. These machines use the force of gravity on moving weights to create the imbalance necessary to achieve the desired rotational torque to power a generator, pump, wheel or other work machine. An obvious advantage of gravity powered machines is that they do not rely on the availability of moving water or wind to achieve the rotational torque at the output shaft that is necessary to power another device. Because gravitational force is constant, its use as the source of input energy frees the machine from reliance on a typically unreliable supply of moving water or wind. A properly designed gravity powered machine will be able to provide or supplement a source of power that is clean, reliable and not dependent on the availability of water, wind or fossil fuels.

Over the years, various machines have been developed to utilize the benefits of gravitational force to rotate an output shaft so that the rotational torque thereof may be utilized to generate electricity or operate another machine. Some of these have been patented. For instance, U.S. Pat. No. 2,989,839 to Croy describes a combined pneumatic and gravity motor having a shaft with radially extending raceways attached thereto and a weight slidably supported on each raceway. The weights are configured to move radially in and out on the raceways by pneumatic force provided by individual air turbines. A timing mechanism controls the air turbines to move the weights to their outer and inner positions and cause rotation of the shaft for use by other machines. U.S. Pat. No. 5,221,868 to Arman describes an electrically assisted gravity powered motor having a series of joined, interrupted axles that each have an outwardly extending arm attached thereto with a weight that moves in and out, relative to the axle, on a track that is attached to the arm. An electric motor moves the weight in and out on the track as the arms rotate. The motors are configured to place the weights on the outer reaches of the arm during the arm's downward rotation and near the axle during the arm's upward rotation to provide higher rotational torque. The rotation of the arms rotates the axle. U.S. Pat. No. 4,311,918 to Vaseen describes a gravity assist booster for a wind powered generator which uses the mechanical advantage of a lever arm to multiply the energy of a moving weight that is wind powered from a propeller drive. The off-balance positioning of the weights, produced by moving the weights around the perimeter of a wheel, uses gravity to facilitate the unit rotating a takeoff shaft. U.S. Pat. No. 6,237,342 to Hurford describes a gravity motor having an output shaft rotatably mounted on a housing that includes a guide surface against which a weighted follower contacts to drive the follower inward towards a hub, to which the output shaft is fixedly attached. The follower is attached to a connecting rod that is telescopically received in a sleeve. The connecting rod moves in and out of the sleeve in response to the follower contacting the guide surface to place the weights near the hub during the upward portion of the cycle and away from the hub during the downward portion of the cycle, resulting in a net torque that rotates the output shaft.

In addition to the foregoing, several gravity powered machines have been published. For instance, US Publication No. 2003/0132635 to Ganimian describes a gravity driven electric power generator comprising a platform member on which is slidably positioned an electric generator housing coupled to an axle having a rotor gear. The rotor gear is in mating contact with a tread member of an endless belt. The platform is pivotally mounted on a stand and a support jack is used to change the orientation of the platform, which causes the generator housing to slide on the platform. Rotation of the endless belt rotates the rotor gear to rotate the axle, which is operatively connected to a generator in the generator housing. U.S. Publication No. 2003/0155770 to Clinch describes a gravity motor comprising an output shaft having a plurality of radial arms secured to the shaft to rotate therewith. At least one weight is slidably connected to each of the radial arms and configured to move radially in and out on the arm as a result of contact against appropriately configured and positioned guide surfaces. The guide surface on the upward portion of the cycle moves the weight inward towards the shaft and the guide surface on the downward portion of the cycle moves the weight outward along the arm, resulting in a net torque that rotates the output shaft for use.

Each of the foregoing patents and publications describe gravity powered machines that utilize the out-of-balance effect of weights on opposite sides of a shaft to create a net torque that rotates an output shaft for use to generate electricity or power another machine, such as a pump or the like. Each of the above machines have limitations and/or disadvantages that, despite the inherent advantages of using gravity to power a machine, have limited their practical use. One such limitation is that the weights end up being too evenly grouped in the opposing drop and lift zones to generate sufficient amounts of net torque that can be used to sufficiently deliver rotational torque to the output shaft for practical benefit. The even grouping of the weights in the drop and lift zones primarily results from the outwardly extending arms being fixedly attached to or at least fixed in position relative to each other and the axle or output shaft, such as the position of the spokes of a water wheel are fixed (as an example). Such a configuration is required in the prior art devices in order to transfer the torque, which results from varying the amount of weight (i.e., water wheel) or the distance between the weight and axle/shaft in the drop or lift zones, to the axle or shaft so that it may be used by another machine.

What is needed, therefore, is an improved gravity powered machine and method that more effectively and efficiently rotates weights around an axle so as to rotate an output shaft for use in generating electricity or to power another machine. The preferred gravity powered machine will more beneficially and efficiently produce torque as a result of the cyclic shift of leverage, momentum and centrifugal forces caused by the independent, relative to each other, rotation of weights around an axle connected to an output shaft and the transfer of the torque created by such weights to the output shaft. Preferably, the gravity powered machine will be relatively simple to manufacture and operate.

### SUMMARY OF THE INVENTION

The gravity powered rotational machine and method of the present invention solves the problems and provides the benefits identified above. That is to say, the present invention discloses a gravity powered rotational machine that rotates a plurality of weights around a pivot bar in a manner that effectively and efficiently generates net torque to rotate an output shaft which can be connected to a generator to generate electricity or to other work machine to accomplish the desired work. The gravity powered rotational machine of the present invention produces a net torque useable at the output shaft as a result of the cyclic shift of leverage, momentum and centrifugal forces caused by the rotation of weights around a stationary pivot bar. The present invention beneficially and efficiently places a greater number of weights in the drop zone and groups these weights closer together, with the weights extended outward from the pivot bar on a leverage railing arm, than the weights in the lift zone, which are spread apart with the weights moved inward towards the pivot bar on the leverage railing arm. As a result, the gravity powered rotational machine of the present invention always has a greater amount of leveraged, extended weight in the drop zone than in the lift zone. In the preferred embodiment, the ratio of the weights in the drop zone to the weights in the lift zone is always constant, thereby providing a constant amount of rotational torque for use by the output shaft to power one or more work machines. In its preferred embodiment, the gravity powered machine of the present invention is relatively simple to assemble and operate.

In one general aspect of the present invention, the gravity powered rotational machine comprises an elongated pivot bar that is supported at its end by a support frame having a plurality of frame members. The pivot bar has a first end section at its first end, a second end section at its second end and a center section that interconnects the first and second end sections. The first end section and the second end section are axially aligned and the center section is axially offset, although generally parallel, to the first and second end sections. In a preferred embodiment, each of the first and second end sections and the center section are generally in the same horizontal plane. A plurality of first swingarm sets are rotatably attached at their first end to the center section of the pivot bar and configured to rotate independently, of each other, around the center section. In the preferred configuration, each of the first swingarm sets comprises a pair of elongated leverage railing arms, a rotating connector at the first end of the leverage railing arms configured to rotate around the center section, an end crossmember bar at the second end of the leverage railing arms that connects them together, a weight member that slidably engages the pair of leverage railing arms and at least one rail roller bearing wheel or like device on the sides of the weight member that rotatably engages the leverage railing arms. The rail roller bearing wheels allow the weight members to move generally between the first and second ends of the first swingarm sets during their rotation around the center section of the pivot bar.

A weight crossmember bar engages, either by passing through or being attached to, each weight member and has its ends extending outwardly from the weight member. Each end of the weight crossmember bar has a channel roller bearing wheel that is configured to rotatably engage one of a pair of channel bar railings, which define a stationary off-center path around the center section of the pivot bar. The path can be circular, oval or a variety of other continuous shapes. The path has a drop zone where the weight members fall and a lift zone where the weight members are lifted. The channel bar railings guide the weight members, through the connection with the channel roller bearing wheels, along the path while the weight members slide inwardly and outwardly on the first swingarm sets. The path is shaped and configured to place the weight members in an extended torque position in the drop zone and in a reduced torque position in the lift zone.

A force transfer mechanism transfers the rotational torque produced in the drop zone to the first swingarm sets in the lift zone by cooperatively engaging each of the first swingarm sets together. In a preferred embodiment, the force transferring mechanism comprises a rotational structure that is rotatably attached to each of the first and second end sections of the pivot bar and a plurality of second swingarm sets that interconnect the rotational structure with the leverage railing arms of the first swingarm sets. The second swingarm sets have a swingarm bar with a first end that is rotatably attached to the rotational structure and a second end that is rotatably attached to the leverage railing arm.

The rotational machine also has a driving mechanism that is engaged with the rotational structure and rotatably supported on at least one of the first and second end sections of the pivot bar. The drive mechanism can comprise meshed gears, a chain gear drive, a belt/pulley drive or other types of drive systems. The drive mechanism interconnects the rotational structure with an output shaft so as to rotate the output shaft, which is operatively connected to a work machine, such as an alternator, generator, pump or other devices.

In operation, once the rotational machine is started and begins to rotate, a plurality of the first swingarm sets will be grouped together in the drop zone with their respective weight members generally in the extended torque position while one or more first swingarm sets are spread apart in the lift zone with their weight members in the reduced torque position, which results in an unbalanced gravitational force and rotational torque. The rotational torque transfers from the first swingarm sets in the drop zone to the rotational structures at the first and second end sections through the second swingarm sets. Some of the rotational torque is transferred through the second swingarm sets to the first swingarm sets in the lift zone to rotate the first swingarm sets to the drop zone. The remaining amount of the rotational torque is transferred to the output shaft through the driving mechanism to power the work machine.

The preferred embodiment of the rotational machine of the present invention also includes a housing that at least substantially encloses the working components of the machine, a braking system for slowing or stopping the machine and a lubrications system for lubricating the working components of the machine. In a preferred embodiment, the housing totally encloses the working components of the machine, with only the output shaft extending therefrom, so the lubrication system can spray lubricating fluid on the working components. The braking system can comprise a brake unit on the exterior of the housing that connects to a shaft that operates a gear, pulley or disc like device to engage the rotational structure and slow or stop the machine. The lubricating system can comprise pumps that pump lubricating fluid through pipes or hoses to spray nozzles supported by the housing and canals in or along the bars and rails and a reservoir to collect excess lubricating fluid for recycling through the machine.

Accordingly, the primary objective of the present invention is to provide a gravity powered rotational machine that provides the advantages discussed above and overcomes the disadvantages and limitations associated with presently available gravity powered machines.

It is also an important object of the present invention to provide a gravity powered rotational machine that utilizes the unbalanced distribution of extended weights in the drop zone versus retracted weights in the lift zone of its operating cycle to generate a net rotational torque for rotating an output shaft for use by a generator or other machine.

It is also an important object of the present invention to provide a gravity powered rotational machine that produces a net torque as a result of the cyclic shift of leverage, momentum and centrifugal forces caused by the rotation of weights around an axle that is connected to an output shaft.

It is also an important object of the present invention to provide a gravity powered rotational machine that is configured to collect together radially extended weights in the drop zone and spread apart the radially retracted weights in the lift zone so as to increase the unbalance of weight and improve the net rotational torque available at the output shaft.

It is also an important object of the present invention to provide a gravity powered rotational machine that comprises frame supporting a pivot arm having a plurality of independent swingarms rotatably attached thereto and a plurality of crossmember bars fixedly attached to and interconnecting a swingarm and one or more flywheels or other rotational structure so as to rotate an output shaft for use by a generator or other machine.

It is also an object of the present invention to provide a gravity powered rotational machine that is relatively simple to assemble and operate so as to generate electricity or power another machine.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side perspective view of a gravity powered rotational machine configured according to a preferred embodiment of the present invention showing a generator as the work machine being powered by the machine;

FIG. 2 is a front view of the gravity powered rotational machine of FIG. 1;

FIG. 3 is a right side view of the gravity powered rotational machine of FIG. 1;

FIG. 4 is a side perspective view of the gravity powered rotational machine of FIG. 1 with a portion of the housing removed to show the working components thereof disposed inside the housing;

FIG. 5 is a front view of the gravity powered rotational machine of FIG. 1 with the housing removed to show the working components of the machine;

FIG. 6 is a top view of the gravity powered rotational machine of FIG. 5 with the top frame member removed for clarity;

FIG. 7 is a top view of the gravity powered rotational machine of the present invention showing a first swingarm set in each of the drop and lift zones with many of the other components removed for clarity;

FIG. 8 is a top view similar to FIG. 7 showing only a limited number of components for clarity purposes;

FIG. 9 is an isolated top view of the gravity powered rotational machine of the present invention particularly showing the pivot bar, connection of the first swingarm sets to the pivot bar, one weight in the lift zone, the rotational structure and the second swingarm sets interconnecting the rotational structure to the first swingarm sets;

FIG. 10 is an isolated side view of the first swingarm sets connected to the channel bar railing that defines a stationary path and the rotational structure;

FIG. 11 is a isolated side view showing the roller bearing connection of the weight member mounted on a single lip bar railing type of channel bar railing and to the leverage railing arm;

FIG. 12 is an isolated side view showing the second swingarm sets interconnecting the rotational structure and the leverage railing arms of the first swingarm sets;

FIG. 13 is an isolated top view of a weight in the extended torque position and connected to the leverage railing arms of the first swingarm sets and to the channel bar railings that define the stationary path and of the second swingarm sets connected to the leverage railing arms;

FIG. 14 is a front view of the components of FIG. 13;

FIG. 15 is an isolated side view showing an embodiment of the gravity powered rotational machine having three first swingarm sets;

FIG. 16 is a side view of the machine with the sides of the housing removed to better show the lubrication system therein;

FIG. 17 is an isolated side view showing an embodiment of the gravity powered rotational machine having channel bar railings defining a generally oval shaped path;

FIG. 18 is an isolated side view showing an embodiment of the gravity powered rotational machine having curved leverage railing arms for the first swingarm sets;

FIG. 19 is a schematic view of one configuration of the gravity powered rotational machine of the present invention;

FIG. 20 is a schematic view of an alternative configuration of the gravity powered rotational machine of the present invention;

FIG. 21 is a schematic view configuration of the gravity powered rotational machine of the present invention; and

FIG. 22 is a schematic view configuration of the gravity powered rotational machine of the present invention.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and represents one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are primarily described as being utilized to provide rotational torque for use by a generator, those skilled in the art will readily understand this is merely for purposes of simplifying the present disclosure and the present invention is not so limited, as the present invention is equally applicable for use with other work machines.

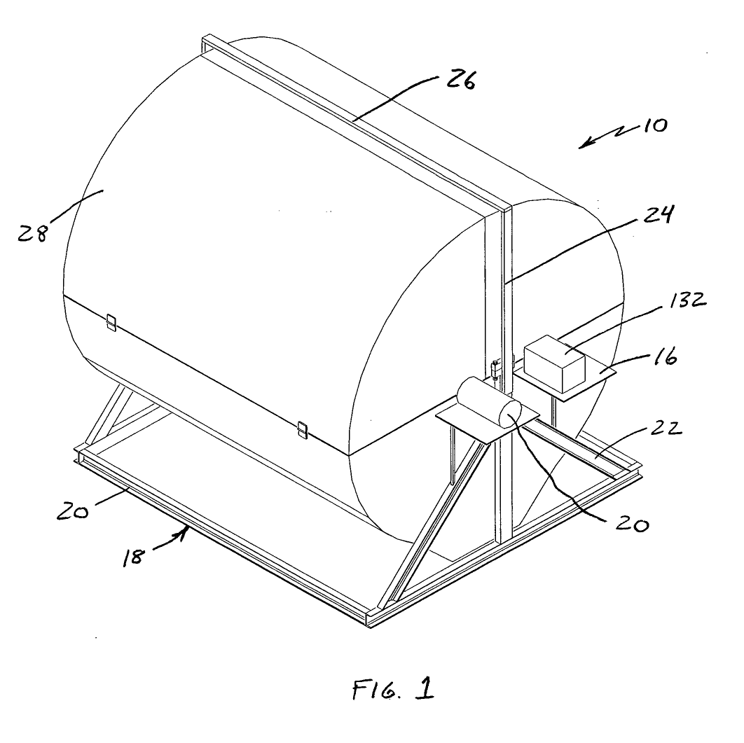

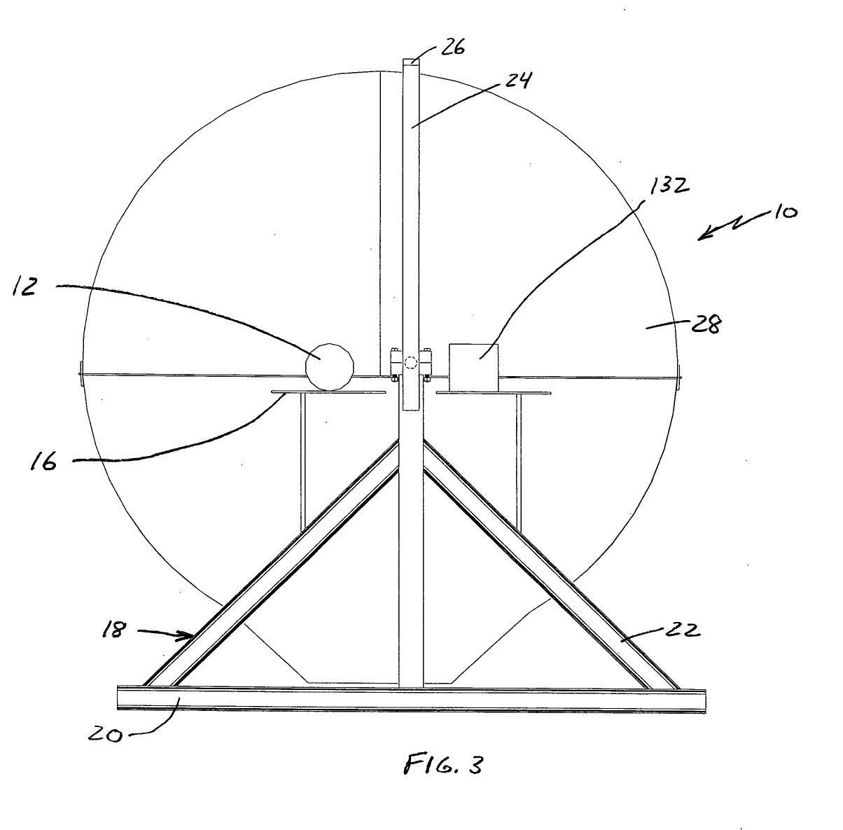

A gravity powered rotational machine that is manufactured out of the components and configured pursuant to a preferred embodiment of the present invention is shown generally as 10 in the figures. Gravity powered rotational machine 10 is configured to provide rotational torque to an electrical generator 12 or other work machine, such as an alternator, pump, wheel or the like, through output shaft 14, which is operatively connected to the work machine 12. In the various embodiments shown in the figures and described herein, work machine 12 is positioned on one of the platforms 16 supported by support frame 18, as best shown in FIGS. 1 through 5. If desired, however, output shaft 14 can be sufficiently long or otherwise configured such that work machine 12 can be physically separate from rotational machine 10. Support frame 18 comprises a plurality of frame members, including base frame members 20, diagonal bracing frame members 22, vertical frame members 24 and the top frame member 26. As set forth below, the frame members of support frame 18 cooperate together to support rotational machine 10 of the present invention during its operation to transfer rotational torque through output shaft 14 to work machine 12.

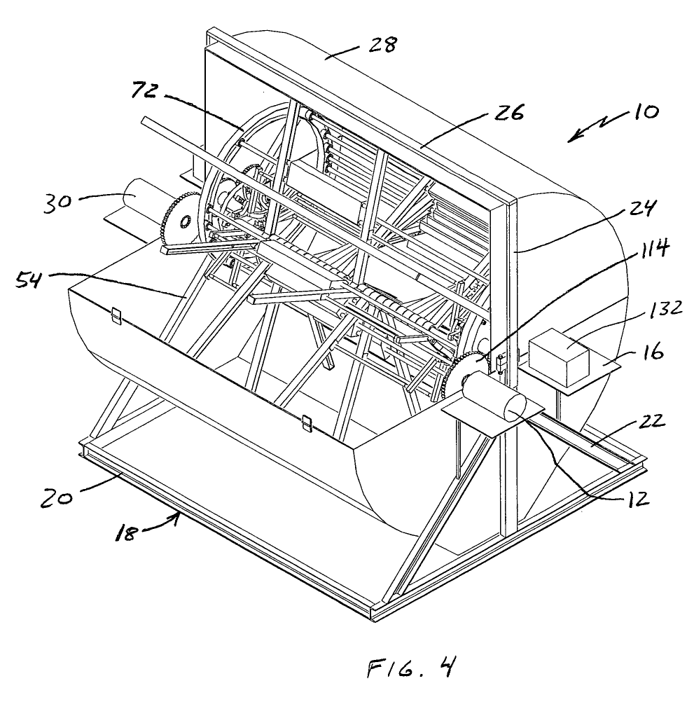

In the preferred embodiment, support frame 18 also supports a machine housing 28 which substantially or fully encloses the various working components of rotational machine 10. As explained in more detail below, an enclosed housing 28 allows the use of a lubrication system that sprays lubricating fluid onto the working components of rotational machine 10. In a preferred embodiment, at least a portion of housing 28, typically one or more of the sections of the top portion of housing 28 (as shown in FIG. 4), can be removed from rotational machine 10 to allow the user to have access to the working components so that he or she may be able to more easily perform routine maintenance or effectuate any necessary repairs. Housing 28 can be manufactured from a wide variety of different materials, including tin, aluminum or other metals, plastics or composite materials that are configured to hold the lubricating fluid within housing 28. In a preferred embodiment, housing 28 is made out of transparent, lightweight, durable and strong plastic material that allows the user to see the operation of the working components of rotational machine 10.

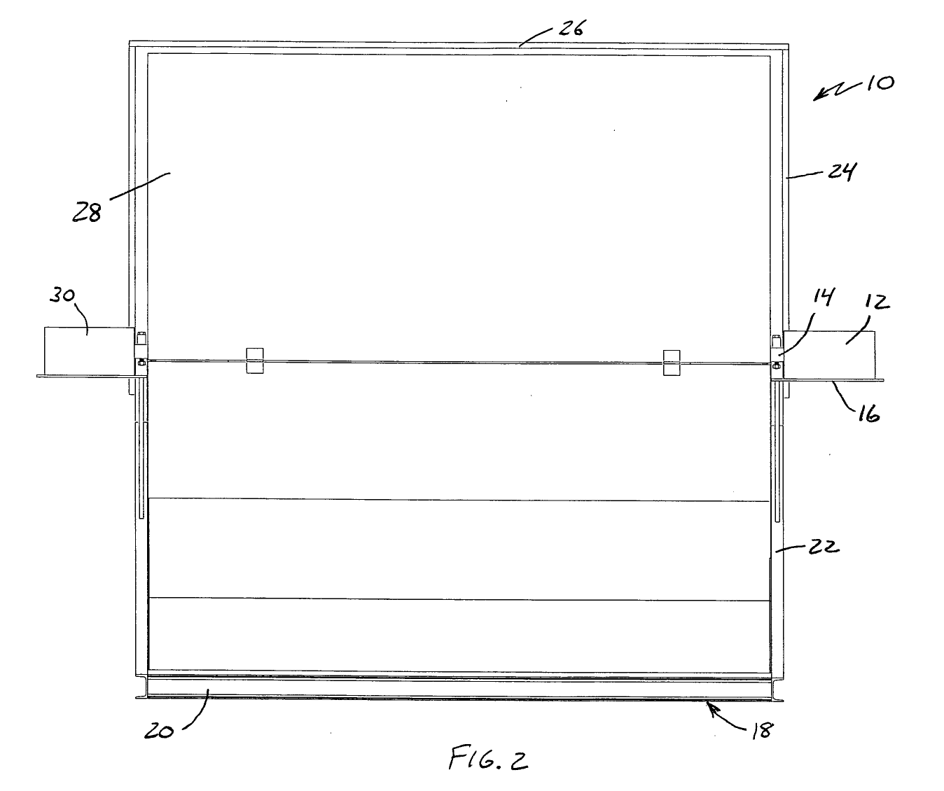

Rotational machine 10 can also have one or more energy input sources 30, such as an electric motor shown in FIGS. 2 and 4 through 6, that is operatively connected to rotational machine 10 to start the operation thereof and to provide additional power boost when needed to overcome the energy lost to friction. Energy input source 30 can be a small electric motor that, preferably, has its energy supplied by another form of readily available and clean source of power, such as wind or solar. As with work machine 12, energy input source 30 can be supported on a platform 16 that is affixed to support frame 14. In addition or as an alternative, one or more additional work machines 12 can be operatively connected to rotational machine 10, depending on the size of rotational machine 10 and the amount of rotational torque produced thereby, to increase the amount of useful work (i.e., generation of electricity).

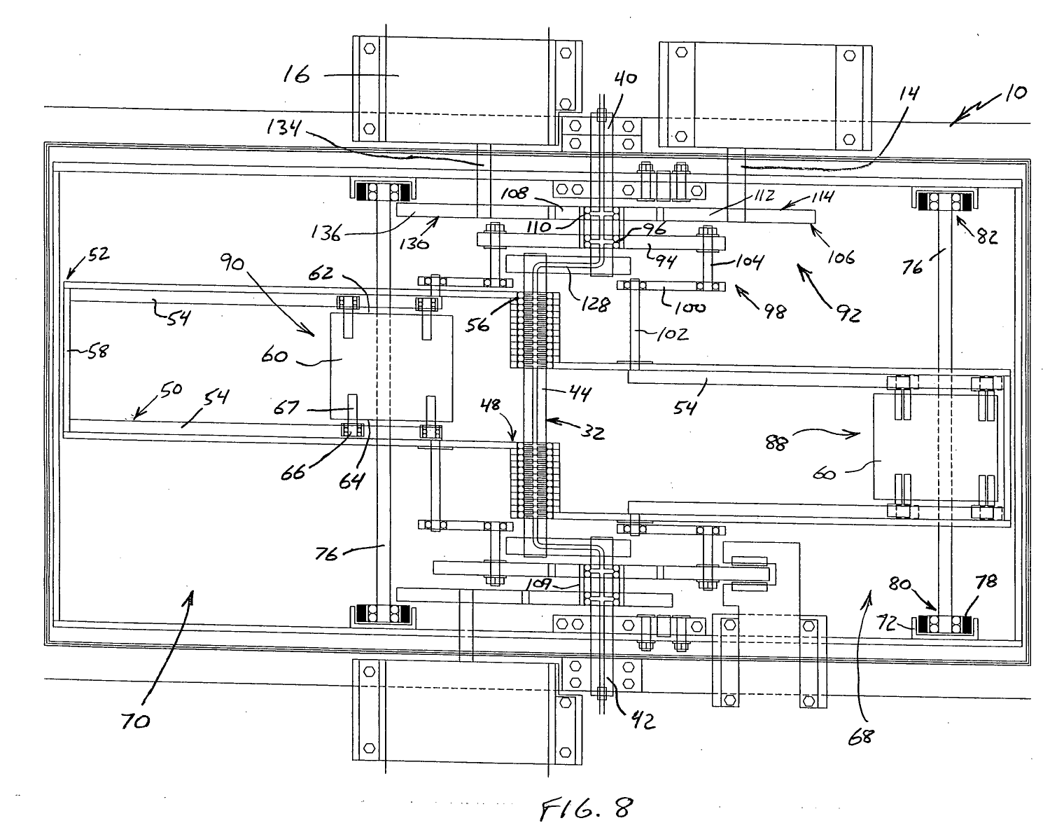

As best shown in FIG. 9, support frame 18 also supports a generally elongated, off-set pivot bar 32 at its first end 34 and second end 36, both of which are fixedly attached to support frame 18 by way of a solid mounting connection 38. In the preferred embodiment, pivot bar 32 has a first end section 40 generally at first end 34, a second end section 42 generally at second end 36 and a center section 44 interconnecting the first end section 40 and the second end section 42. First end section 40 and second end section 42 function as the main stationary crossmember rotation pivot bar and center section 44 functions as the interior extension stationary crossmember rotation pivot bar. As shown in FIG. 9, the first end section 40 and the second end section 42 are axially aligned and the center section is axially offset so as to extend outwardly in the direction of the lift zone (described below) and generally parallel to the first end section 40 and the second end section 42. The preferred embodiment also has each of the first end section 40, second end section 42 and center section 44 in the same, preferably horizontal, plane. One or more extension members 46 interconnect the first end section 40 and the center section 44 and the center section 44 with the second end section 42. As explained in more detail below, the joined first end section 40, second end section 42 and center section 44 are cooperatively configured to provide the necessary clearances to allow other components to rotate around the respective sections. Unlike prior art gravity motors and like gravity powered devices, however, the pivot bar 32 itself does not rotate in response to the rotation of the weighted members, which rotate around and relative to pivot bar 32, which produces the weight/torque imbalance and achieves the desired rotational torque at output shaft 14 to power work machine 12. Although shown generally horizontal, center section 44 does not necessarily have to be so configured. Alternatively, center section 44 can be angled up or down relative to first 40 and second 42 end sections, which may improve performance of the rotational machine 10.

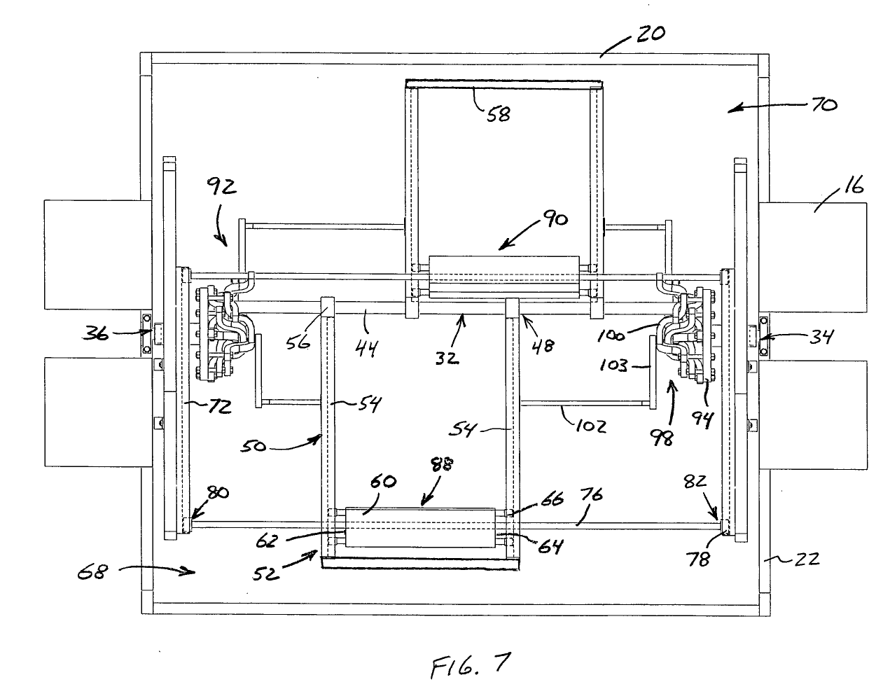

Rotatably attached at their first end 48 to the center section 44 of pivot bar 32 are a plurality of first swingarm sets 50, best shown in FIGS. 7 and 8, having the second end 52 thereof extending outwardly from center section 44. As shown in FIG. 4, each of the first swingarm sets 50 are configured to rotate around center section 44 independently of each other, meaning that the circumferential relationship between adjacent first swingarm sets 50 is not fixed relative to each other, making the present invention unlike the spokes of the water wheel or radial arms of prior art gravity devices. As such, an individual first swingarm set 50 is free to rotate around center section 44 slower or faster at a given time than any other of the first swingarm sets 50 and free to rotate slower or faster during different portions of its cycle around center section 44. As explained below, this allows the rotational machine 10 of the present invention to achieve higher differential torque on opposite sides of rotational machine 10, resulting in higher rotational torque at output shaft 14.

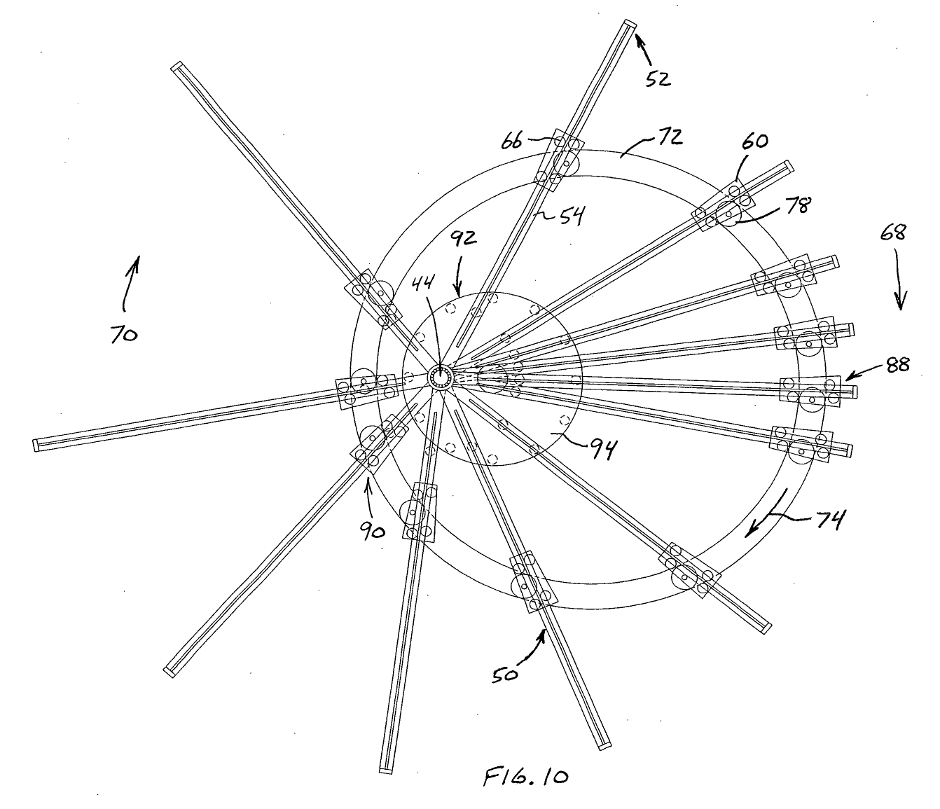

In a preferred embodiment of the present invention, each of the first swingarm sets 50 comprises a pair of spaced apart leverage railing arms 54 having a rotating connector 56 at the first end 48 of first swingarm sets 50 that allows the pair of leverage railing arms 54 to rotate around center section 44 and an end crossmember bar 58 at the second end of first swingarm sets 50 that connects the two leverage railing arms 54 together to hold them parallel to each other and to ensure that each of the first swingarm sets 50 move as a single unit. Preferably, the rotating connections 56 at center section 44 are spaced apart from each other with the use of spacing shims or the like. Each of the first swingarm sets 50 also comprises a weight member 60 that is slidably engaged with the pair of leverage railing arms 54 so as to slide inward towards first end 48 and outward towards second end 52 during the rotation of the first swingarm sets 50 around center section 44. Attached to the first 62 and second 64 sides of weight member 60 is at least one rail roller bearing wheel 66, with four shown in FIG. 11, that are each configured to rotatably engage one of the pair of leverage railing arms 54 so that weight member 60 may move generally between the first 48 and second 52 ends of first swingarm sets 50 during its rotation around center section 44.

The number of first swingarm sets 50 for rotational machine 10 can vary greatly. A number of the figures utilize twelve first swingarm sets 50. Although, rotational machine 10 can have any number division of 360 degrees, the selection of whole numbers of 360 degrees simplifies the task of designing and putting together the components of rotational machine 10. The choice of the number of first swingarm sets will affect the spacing of the connections to the force transfer mechanism, discussed below, and the overall size and output of rotational machine 10.

As known to those skilled in the art, the leverage railing arms 54 can be configured in a number of different ways, including single flange type railing bars, channel type railing bars (composed of two flanges), pipe type railing bars, pipe with slot in it type railing bars (for a roller bearing ball type roller connection) and any bar type, railing, pipe type, or structure that allows the weight member 60 to roll, glide, or move inward and outward on the first swingarm sets 50 during their rotation about center section 44. The rotating connector 56 at the first end 48 of first swingarm sets 50 can be a roller bearing, journal or other type of rotating connection that rotatably connects the leverage railing arms 54 to the center section 44. In one embodiment, rotating connectors are roller bearing connections, however, with the lubrication system described below (i.e., having a lubrication canal system throughout the pivot bar 32, journal rotary connections are believed to be better for the rotating connectors 56 for constant high speeds and weight endurance.

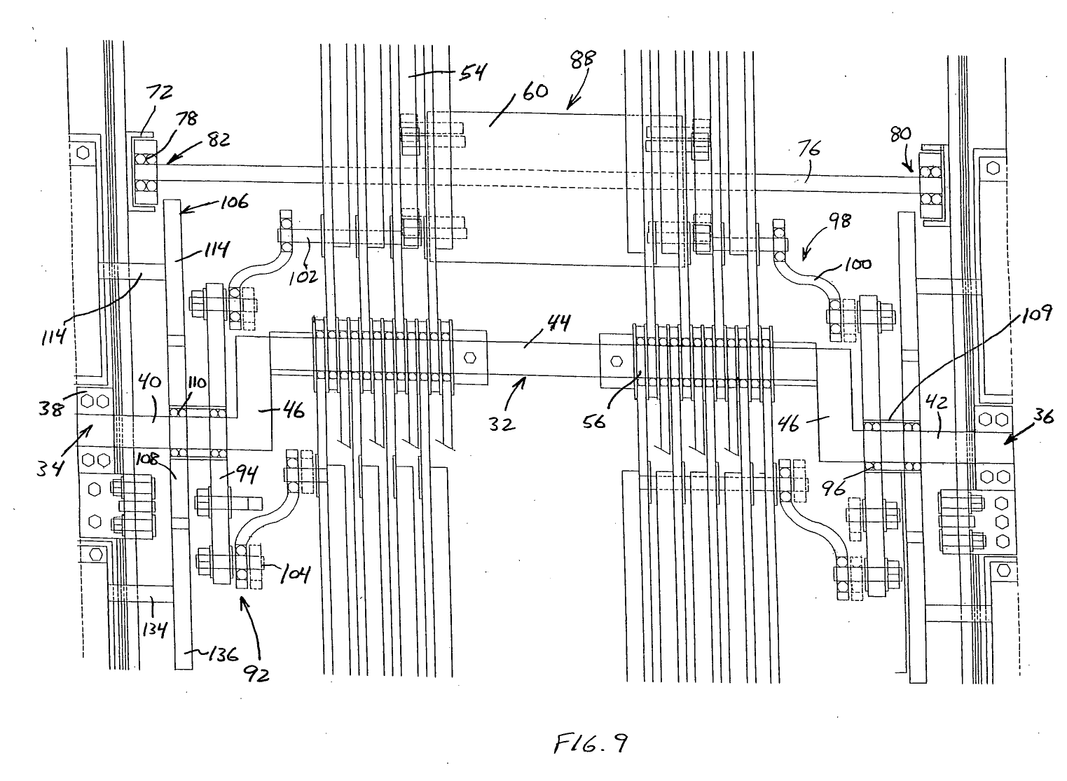

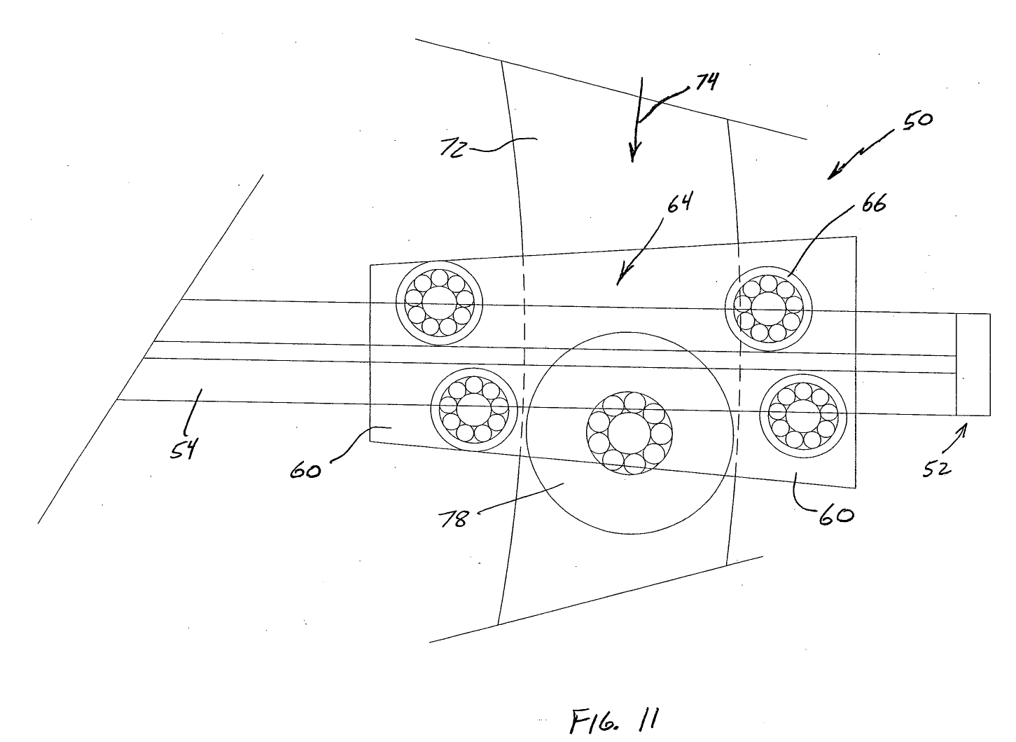

As stated above, weight members 60 slidably engage the leverage railing arms 54 so as to roll, glide or otherwise move inward and outward on the leverage railing arms 54 as the first swingarm sets 50 rotate around center section 44 of pivot bar 32 to create the gravity rotational force of rotational machine 10. As such, the positioning, leverage extension and concentration of the weight from weight members 60 is important to the operation of rotational machine 10. The size and the weight of the weight members 60 is also very important. In general, the heavier the weight members 60 the more gravitational rotational power force the rotational machine 10 will have. In the preferred embodiment, there is one weight member 60 per first swingarm set 50. Although it is preferred that the weight members 60 be slidably engaged with the leverage railing arms 54, to move inward and outward thereon, alternatively they can be fixedly attached to the leverage railing arms 54 (though it is believed this would substantially reduce the benefits of the present invention). Even without the leverage extensions of the weight members 60 going inward and outward on the leverage railing arms 54 (in the correct areas of the rotational machine 10), the inner core process creates a greater number of weight members 60 in the power drop zone area, shown as 68, of the rotational machine 10 and a far less number of weight members 60 in the lift zone area 70 of rotational machine 10 (the drop zone area 68 and lift zone area 70 are best shown in FIGS. 10 and 12), which is one of the key aspects of the function of rotational machine 10. The type of material utilized for weight members 60 is also very important, as the heavier the weight members 60 are for their size the better. The weights can be made of: (1) steel, which is heavy for its size, and is very strong and enduring; (2) lead, which may be best due to its extremely heavy for its size; or (3) concrete, would be good, for it is not nearly as expensive as steel, lead or other heavy metals, and it is very heavy. In addition, weight members 60 could be a combination of materials. The weight members 60 could be made of strong plastic or aluminum containers that would be filled completely with water or other fill material, so that the water or fill material wouldn't be jarring around in the containers, likely disrupting the rotation of the rotational machine 10. Basically, weight members 60 can be made of any material that has a lot of weight, and will hold together and last.

Attached at the sides 62 and 64 of weight members 60 are rail roller bearing wheels 66, which allow the weight members 60 to roll inward and outward on the first swing arm sets 50, as best shown in FIGS. 8, 9, 11 and 13. If desired, a weight rod or bar 67 can interconnect the weight members 60 with the rail roller bearing wheels 66. The ends of weight rod or bar 67 can be fixedly attached to weight members 60 and/or the rail roller bearing wheels 66 or they can have a bearing connection thereto, which may improve the performance of rotational machine 10. The rail roller bearing wheels 66 ride on both sides of the single flanges of the leverage railing arms 54 of the first swing arm sets 50. In an embodiment where the leverage railing arms 54 are configured as a pipe with a slot in the pipe, the rail roller bearing wheels 66 can be a ball-type configuration that rides within the pipe. Basically, anything that makes it possible for the weight members 60 to roll, glide, or move inward and outward on the first swing arm sets 50 can be utilized with the rotational machine 10 of the present invention.

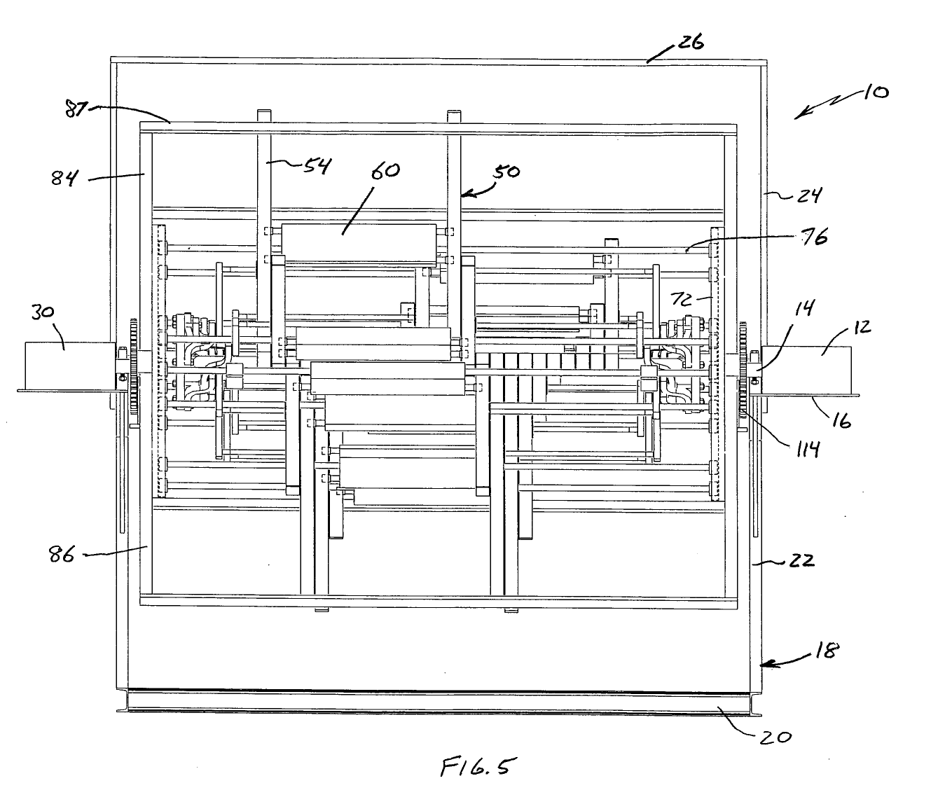

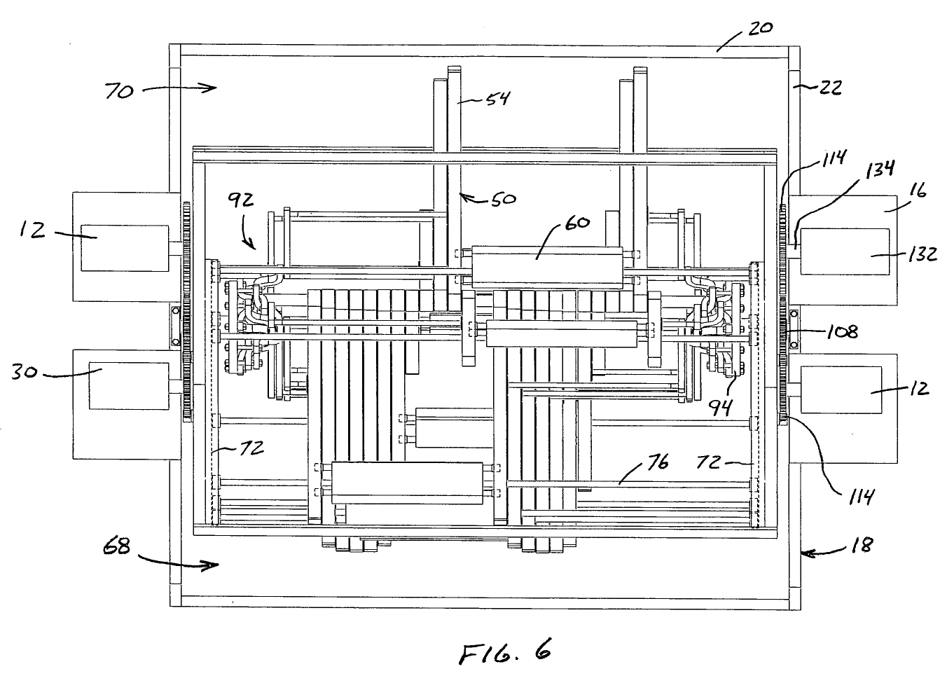

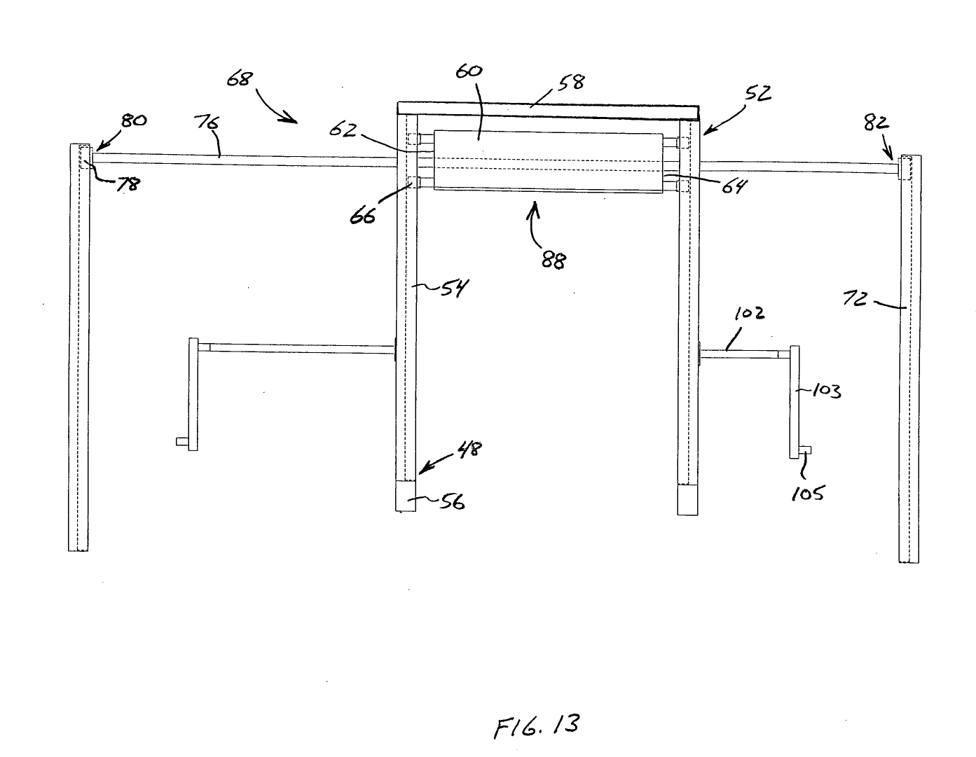

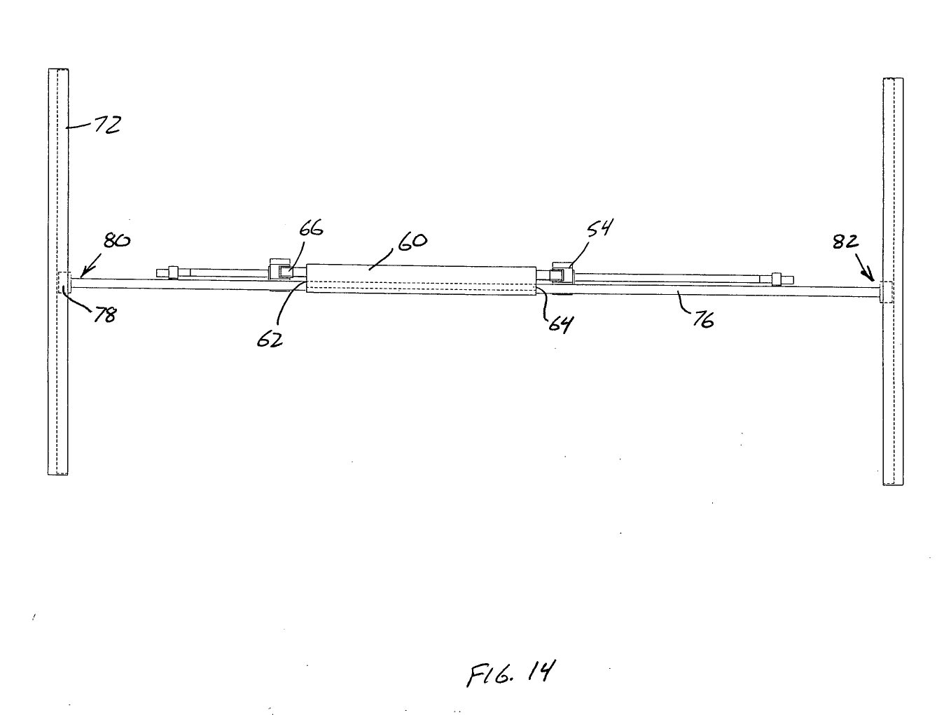

As stated above, the plurality of first swing arm sets 50 rotate around the center section 44 of pivot bar 32 as the weight members 60 slide inwardly and outwardly on the leverage railing arms 54. As well understood by those skilled in the art, centrifugal forces would drive the weight members 60 toward the second end 52 of the first swingarm sets 50 and keep them there while the rotational machine 10 was in operation. To control the movement of weight members 60 during the rotation of first swingarm sets 50 around center section 44, and thereby prevent the weight members 60 from riding at the second ends 52 of the first swingarm sets 50, rotational machine 10 has one or more channel bar railings 72 around center section 44 that define a stationary, off-center path 74 that the weight members 60 follow as they rotate around center section 44, best shown in FIGS. 10, 11, 15 and 17. In the preferred embodiment, path 74 is defined by a pair of channel bar railings 72, as shown in FIGS. 5 through 9, that positioned outwardly beyond the ends of center section 44. To force the weight members 60 to follow path 74 as the first swingarm sets 50 rotate around center section 44, each of the weight members 60 has a weight crossmember bar 76 engaged therewith and extending outwardly therefrom so a channel roller bearing 78 at each of the first end 80 and second end 82 of weight crossmember bar 76 rotatably engages the pair of channel bar railings 72, as best shown in FIGS. 6 through 11, 13 and 14. As shown in FIG. 16, a pair of fixed mounted diagonal bracing members 84 and 86, attached to support stand 18 directly or to the first 40 and second 42 end sections of pivot bar 32 that is supported by support frame 18, support the pair of channel bar railings 72 in the desired position. As will be readily understood in the art, the bracing members 84 and 86, as well as the other components of support frame 18, must be sufficiently sturdy to withstand the forces generated by the rotating first swing arm sets 50.

The weight crossmember bar 76, which goes through the weight members 60 in one embodiment, has either a solid or a roller bearing connection within the weight members 60 and extends out from both sides 62 and 64 thereof to the channel bar railings 72 that define path 74. In another configuration, the weight crossmember bar 76 is two separate sections that each extend outwardly from the sides 62 and 64 thereof toward channel bar railings 72. The channel roller bearings or wheels 78 at the ends 80 and 82 of weight crossmember bar 76 rides within or on the channel bar railings 72. As will be readily understood by those skilled in the art, the channel bar railings 72, weight crossmember bar 76 and channel roller bearings/wheels 78 can be configured in a number of different ways to achieve the operation described herein. For instance, the following configurations are possible: (1) a single channel roller bearing/wheel 78 at each end of the weight crossmember bar 76 to roll within stationary channel bar railing 72; (2) single roller bearing balls at each end of the weight crossmember bar 76 to ride within channel bar railings 72 configured as circular or oval pipes having an open slot therein to receive one end of weight crossmember bar 76; (3) roller bearings/wheels 78 at both ends of the weight crossmember bar 76 that ride on both sides of the single flanges to the stationary channel bar railing 72 that defines path 74; and/or (4) any other railing system of structure that guides and directs weight members 60 around path 74 and inward and outward on first swingarm sets 50.

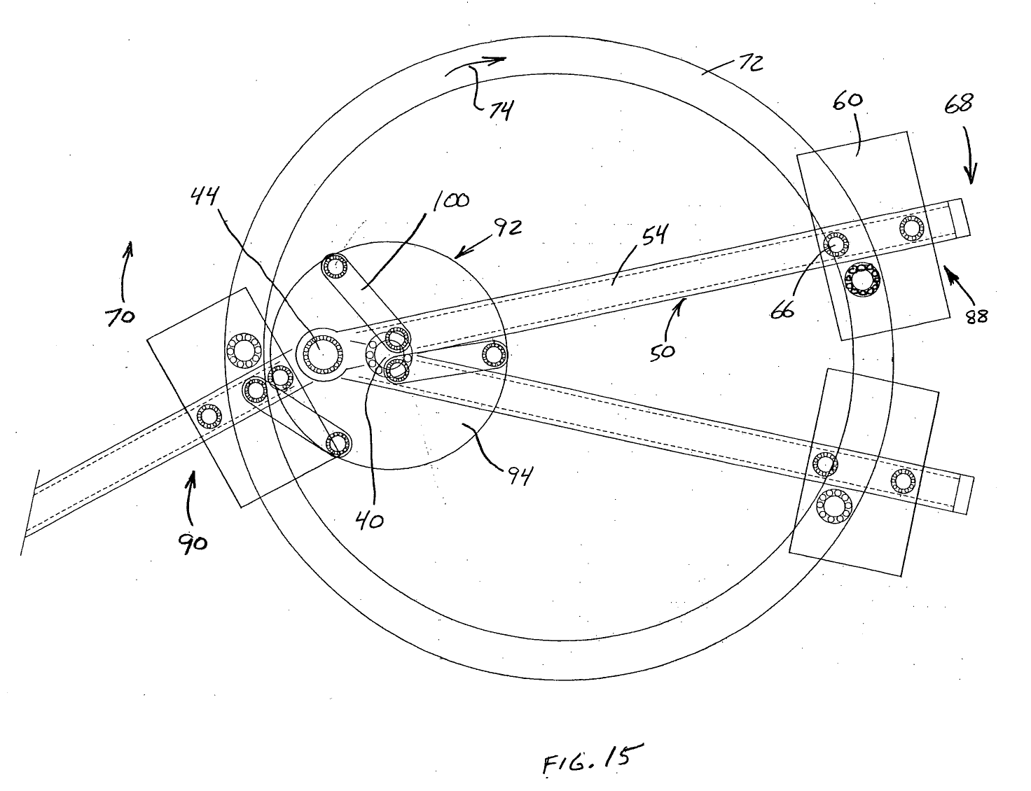

To achieve the desired torque differential for rotational machine 10, path 74 is configured in an off-center shape, as shown in FIGS. 10 and 15 through 18, such that the side of the path 74 in the lift zone 70 is closer to the axis of center section 44 in the drop zone 68. In a preferred embodiment, path 74 is much closer to center section 44 when in the lift zone 70 than when it is in the drop zone 68. The shape of path 74, defined by channel bar railings 72, can be generally circular (FIG. 10), oval (FIG. 17), egg-shaped, teardrop, uneven circular or oval or a variety of other shapes. The key aspect of the shape of path 74 is that it is positioned closer to the center section 44 in the lift zone 70 side than in the drop zone 68 side so that weight members 60 will be forced to slide inwardly, towards the first end 48 of first swingarm sets 50, on leverage railing arms 54 as they move from the drop zone 68 to the lift zone 70. In this manner, the path 74 will be configured to place the weight members 60 in an extended torque position 88 in the drop zone 68 and in a reduced torque position 90 in the lift zone 70, as best shown in FIGS. 7, 8 and 10, such that the torque resulting from the leveraged extension of weight members 60 will be greater in the drop zone 68 than in the lift zone 70 for any given first swingarm set 50 as it rotates around center section 44.

The torque generated by the falling first swingarm sets 50 in the drop zone 68, with weight members 60 in their extended torque positions 88, is transferred by a force transfer mechanism 92, shown in FIGS. 6 through 9, to assist in lifting the weight members 60 in the lift zone, with weight members 60 in their reduced torque positions 90, and to rotate output shaft 14 to power work machine 12. Although some amount of first swingarm sets 50 in the lift zone 70 will be accomplished by the momentum resulting from them falling in the drop zone 68, this force will generally not be sufficient to lift the first swingarm sets 50 through the entire lift zone 70. Instead, force transfer mechanism 92 lifts the first swingarm sets 50 in the lift zone 70 and transfers the excess force to output shaft 14 via a driving mechanism discussed below. In a preferred embodiment, force transfer mechanism 92 comprises a rotational structure 94, such as a harmonic balance flywheel or the like, at each of first end section 40 and second end section 42 of pivot bar 32. The rotational structures 94 are rotatably attached to first end section 40 and second end section 44 such that it is free to rotate relative to the respective end sections 40 or 42 on which the rotational structure 94 is mounted. The rotational structures 94 can be manufactured out of a variety of different materials, such as steel, aluminum, plastic, composites or a combination of these or other materials. In a preferred embodiment, steel is utilized so that the rotational structures 94 can be used as heavy rotational balancing wheels to true the rotational machine 10 as it rotates rapidly around pivot bar 32, to keep the rotational machine 10 rotating smoothly. Naturally, the rotational structures 94 would have to be manufactured and installed balanced and true.

In a preferred embodiment, the rotational structure 94 has a rotary bearing connection 96 that rotatably engages either the first end section 40 or the second end section 40, as best shown in FIGS. 8 and 9. Interconnecting each leverage railing arm 54 of each of the first swingarm sets 50 and the rotational structures 94 at first 40 and second 42 end sections is a second swingarm set 98 comprising, a second swingarm 100 that is rotatably connected to one end of a first transfer crossmember bar 102 and rotatably connected to one end of a second transfer crossmember bar 104. In the preferred embodiments, shown in FIGS. 5 through 7, 9 and 12, second swingarms 100 are curved to achieve the clearances needed with each other and for the clearances with their rod and bar rotary bearing connections from both the rotational structure 94 and the leverage railing arms 54 of the first swingarm sets 50. In FIGS. 8 and 15, the second swingarms 100 are straight. The rotary connections to the second swingarm 100 provide a smoother and faster rotational connection, which benefits rotational machine 10. The opposite end of first transfer crossmember bar 102 is fixedly connected to one of the leverage railing arms 54 and the opposite end of the second transfer crossmember bar 104 is fixedly connected to one of the rotational structures 94, as best shown in FIGS. 8 and 9.

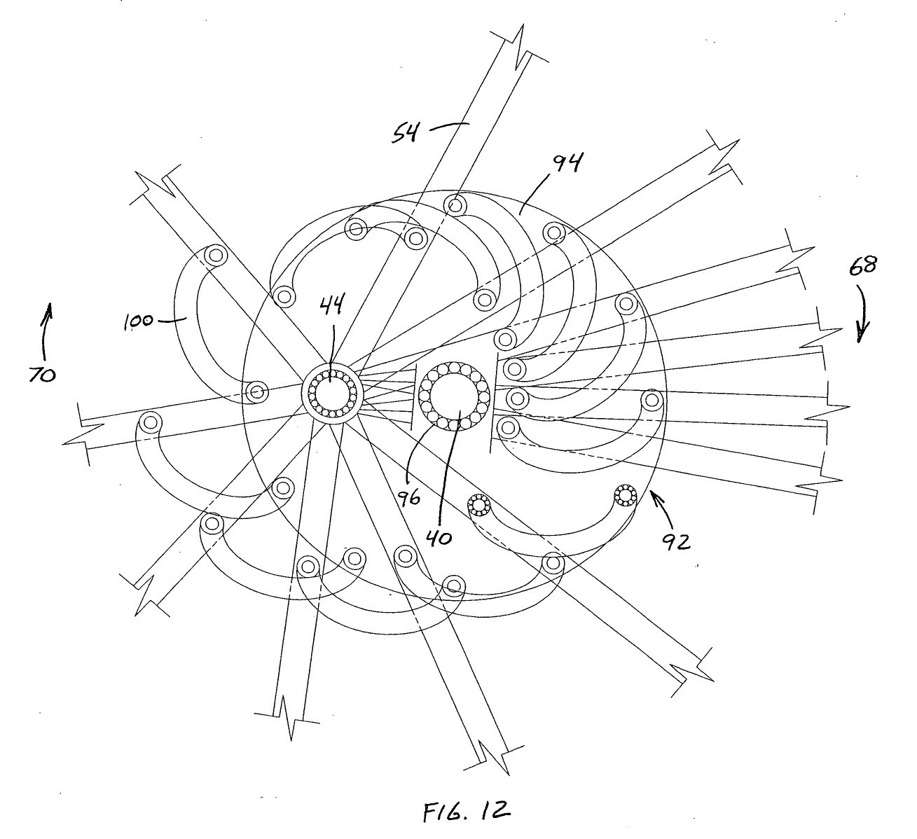

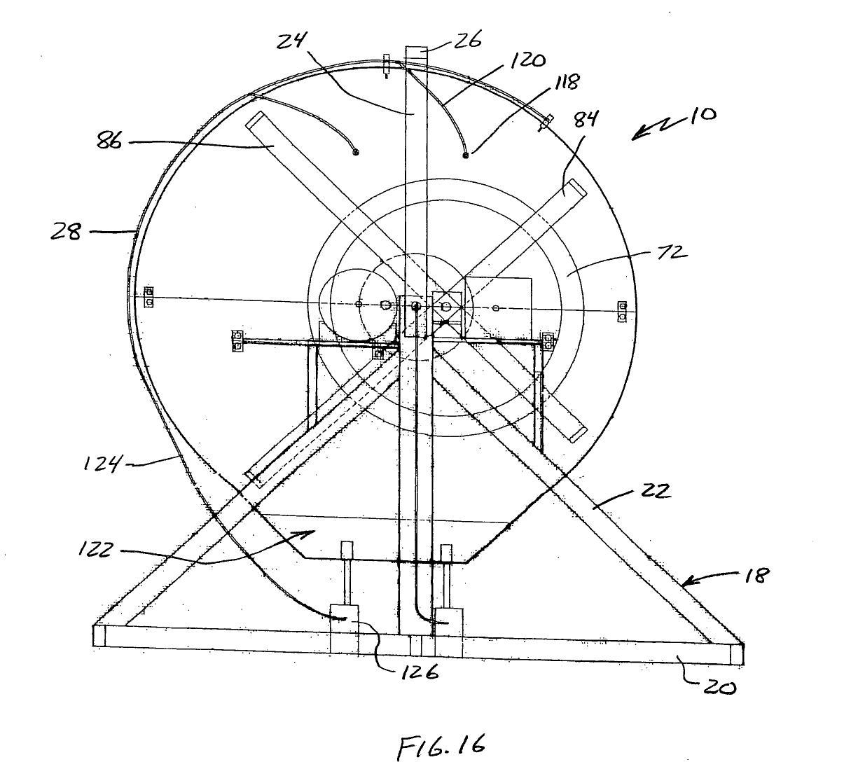

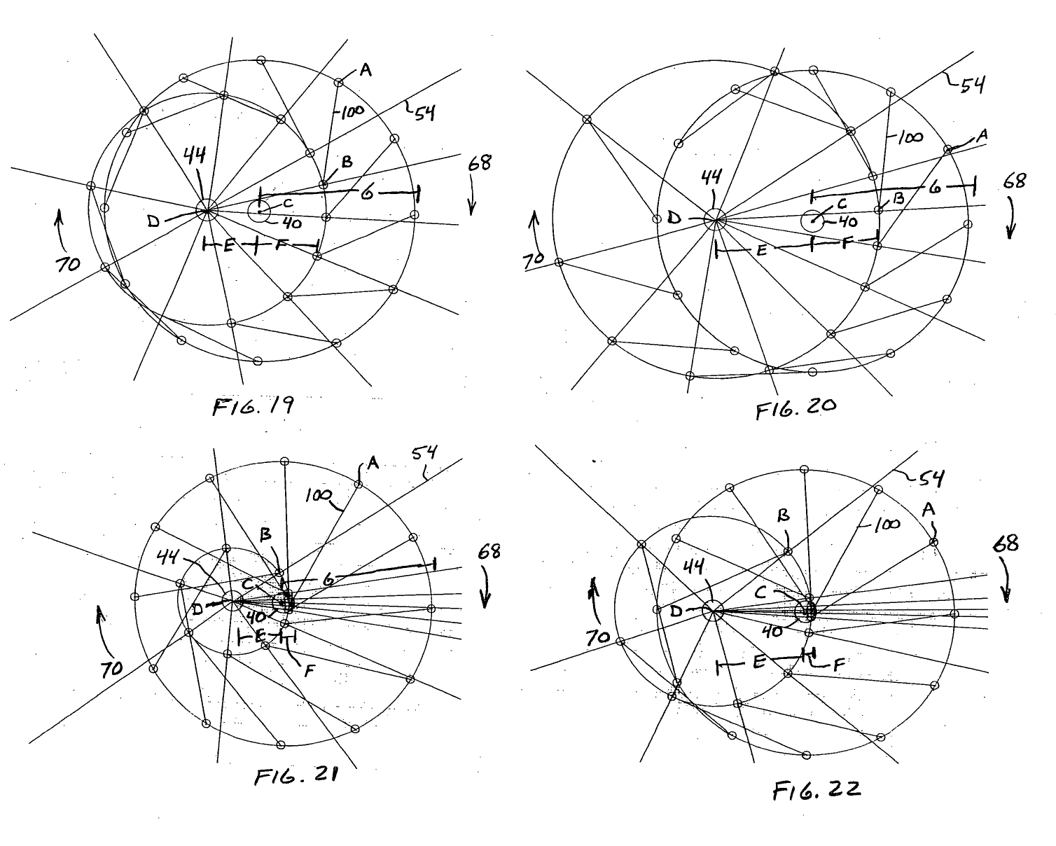

The second swingarms 100 alternate back and forth on their respective rod or bar rotary connections. The last one alternates in three different planes so that they have the necessary clearances with their rotary connections to each other. Because the first swingarm sets 50 scissor together so closely, the rotary connections of the second swingarm sets 98 are connected to an extension rod or bar that extends outward to the first transfer crossmember 102 to leverage railing arms 54 (to a further outward connection of the crossmember so that the are able to cross through the swinging first swingarm sets 50 to the solid attachments to their respective leverage railing arms 54 to connect thereto). FIG. 9 shows two separate alternating planes of their connections. As shown in FIGS. 5 and 6 show the three separate planes of alternation with the rotary connections of the second swingarm sets 98. When rotational machine 10 is configured such that the first swingarm sets 50 scissor together very close, such as show in FIGS. 21 and 22, they have to have additional extension rods or bars from the rotary connection of the second swingarms 100 to the further outward first transfer crossmember 102 to the leverage railing arms 54 of the first swingarm sets 50. As best shown in FIG. 13, the use of a first extension member 103 and a second extension member 105, which are utilized in the embodiments of FIGS. 4 through 7, provide the additional connection between the second swingarms 100 and the leverage railing arms 54. The second swingarm 100 has a rotary connection to second extension member 105, which has a solid connection to first extension member 103 and a solid connection to first transfer crossmember 102 that fixedly connects to leverage railing arm 54. In the embodiment having generally straight leverage railing arms 54, the second extension members 105 are basically parallel to the leverage railing arms 54. When the leverage railing arms 54 are curved, such as shown in FIG. 18, the second extension members 105 are in a fixed angle relative to the leverage railing arms 54 so they can be curved in the desired direction for the weight members 60 to have the least amount of friction and drag in the drop zone 68 and lift zone 70, as set forth in more detail below.

As explained in more detail below, in operation the rotation of the first swingarm sets 50 around center section 44 results in the second swingarm sets 98 transferring its rotation and the torque from the moving weight members 60 to the rotational structure 94 by way of first transfer crossmember 102, second swingarm 100 and second cross member 104. Force is transferred, in a pull down type of direction, from each of the first swingarm sets 50, with their weight members 60 extended, in the drop zone 68 to the rotational structure 94, from which the force is transferred to the first swingarm sets 50 in the lift zone 70, in a generally upward pushing type of direction, with the excess force being transferred to output shaft 14 to power work machine 12. In general, the second swingarm set 100 pushes first swingarm set 50 over and up in the lower area of the lift zone 70, pushes upward in the center area of the lift zone 70 and pushes up and over in the upper area of the lift zone 70.

The excess rotational torque available to power work machine 12 is transferred from rotational structure 94 to output shaft 14 by a driving mechanism 106, best shown in FIGS. 4 through 6, 8 and 9. In a preferred embodiment of rotational machine 10 of the present invention, driving mechanism 106 comprises two or more drive device, such as interlocking gears (FIGS. 4 through 6) or a pair of sprockets, pulleys or the like, that are operatively connected by a chain, belt or other drive member. In FIGS. 4 through 6, first drive device 108 is a gear that meshes with the second drive device (gear) 114. In FIGS. 7 through 9, the first drive device 108 is a pulley that is connected to rotational structure 94 by use of a solid collar sleeve 109, so as to rotate therewith and provided with rotary bearing connection 110 to rotate around first 40 or second 42 end sections with rotational structure 94. A drive member 112, such as the belt shown in FIGS. 8 and 9, connects to second drive device 114, which is fixedly attached to output shaft 14 to rotate it and transfer the rotational torque to work machine 12. The driving mechanism 106 is on the outside of the diagonal bracing members 84 and 86 that hold the stationary railing 72, which defines path 74, in place and inside of the support frame 18 and housing 28. As a result, the driving mechanism 106 has its own working plane that it connects and rotates around, as best shown in FIGS. 4 through 6.

The long first swingarm sets 50 are a complete set of working parts that makes up one rotational set for the rotational machine 10 of the present invention. In one preferred embodiment, there are twelve first swingarm sets 50. Each of the first swingarm sets 50 have a rotating connection 56, such as a rotary bearing connection, at the first end of first swingarm sets 50 where it rotatably connects to the center section 44 of pivot bar 32. All of the first swingarm sets 50 rotate rapidly around center section 44 and they all connect to the rotational structure 94 of the force transfer mechanism 92 by way of a second swingarm set 98, including curved swingarms 100. Each of the first swingarm sets 50 also have a channel roller bearing wheel 78 connected to the channel bar railings 72 that define, in preferred embodiments, a circular or oval path 94 (path 94 can be an uneven circular or oval shape). The channel roller bearings 78 are at the ends 80 and 82 of a weight crossmember bar 76 that engages or goes through the weight members 60 components of the first swingarm sets 50. As the first swingarm sets 50 rotate around the center section 44, the channel roller bearing wheels 78 ride within or on the channel bar railings 72 to move the weight members 60 outwardly toward the second ends 52 of first swingarm sets in the drop zone 68 and inwardly toward the first ends 48 thereof in the lift zone.

The preferred embodiment of the rotational machine 10 of the present invention also includes a lubricating system 116, best shown in FIG. 16, that lubricates all the moving parts to the process of the rotating machine 10. As stated above, the housing 28 encloses rotating machine 10 so the lubrication fluid can be contained therein. Preferably, the lubricant fluid is sprayed on the moving parts of the rotational machine 10 through spraying fittings or jets 118 that are attached to the top and the sides of the housing 28 by hoses 120 or the like. The excess lubrication fluid, after it drains down from the parts of the rotating machine 10 and the sides of housing 28, collects in reservoir 122 at the bottom of housing 28 to be recycled again and again in rotational machine 10. The transfer pipes or hoses, shown collectively as 124 in FIG. 16, transport the lubricant to the different lubricant fittings or fixtures from the lubrication pumps 126, such as to the outer fittings on the pivot bar 32 for distribution through its lubricating canal system 128, best shown in FIG. 8, for its lubricated rotary connections or to the lubricating spray jets 118 on housing 28. The pumps 126 circulate the lubrication fluid from the reservoir 122 of housing 28 to the lubrication canal systems 128 that passes through the pivot bar 32 to the various moving parts, such as the rotating connectors 56 at center section 44, and to the lubricating spray jets 118 on housing 28. Preferably, the various materials used for the moving parts of rotational machine 10 are selected for their low friction properties and to benefit by the addition of the lubricating system 116.

The preferred embodiment of the rotational machine 10 of the present invention also includes a braking mechanism 130 for slowing or stopping the rotational machine 10. In the embodiment in the figures, braking mechanism 130 comprises a braking unit 132 supported on one of the platforms 16 supported by support frame 18, preferably on both sides of housing 28 so that it will slow or stop rotational machine 10 evenly, as shown in FIGS. 1, 3, 4 and 6. Braking unit 132 is operatively connected to a braking shaft 134, best shown in FIGS. 6, 8 and 9, that extends through housing 28 to engage rotational structure 94, with the use of gears, sprockets, pulleys or the like 136 or directly in a manner similar to disc brakes.

### Operational Setting Considerations

There are at least fourteen settings that have to be considered in the process of the working inner core of the gravity powered rotational machine 10 in setting the measurement distances, lengths, spacings, angles, ratios, clearances, sizes, materials, etc., to receive the most gravitational rotational power force performance from the rotational machine 10. These are:

1. The equally spaced circular degree circumference connections on the outer perimeter area of the rotational structures 94 to the second swingarm sets 98 for the number of first swingarm sets 50;

2. The extension distance ratio measurement of the horizontal extension of the center section 44 of pivot bar 32 in the lift zone 68 side from the horizontal center of the first 40 and second 42 end sections to the perimeter area through the center of the second swingarm sets 98 connections on the rotational structures 94;

3. The horizontal distance from the horizontal center line of the first 40 and second 42 end sections of pivot bar 32 in the power drop zone 68 side of the rotational machine 10 for the rotary connections of the second swingarm sets 98 to the first swingarm sets 50;

4. The length measurement of the first swingarm sets 50 from the center section 44 to their rotary connection of the second swingarm sets 98 past the horizontal center line of the first 40 and second 42 end sections of pivot bar 32;

5. The length and angle of the second swingarm sets 98 from the rotational structures 94 to the rotary connection 56 of the first swingarm sets 50 in its horizontal position past the horizontal center line of the first 40 and second 42 end sections. The second swingarm set 98 has to be in a pull down angle position from the rotational structure 98 to the first swingarm sets 50 (when one length measurement is obtained for the second swingarm sets 98, all of the length measurements are obtained since they are all the same length);

6. Size of the rotational structures 94;

7. Length of the first swingarm sets 50;

8. The horizontal length of the center section 44;

9. The size of weight members 60;

10. The size of the rotational machine 10 in general (whatever size is wanted) and how much gravity powered rotational force at output shaft 14 is necessary to power work machine 12;

11. The size of the parts of the rotational machine 10;

12. Types of rotational connections, ball bearings, roller bearings, journals, magnetic bearings and etc.;

13. The type of leverage railing arms 54 for first swingarm sets 50 (i.e., whether to utilize single flange bar type railing, channel bar type railing or etc.); and

14. Size and type of the stationary circular, oval or uneven circular or oval shaped channel bar railings 72 that define path 74.

The four main settings of the main working inner core process to the gravity powered rotational machine 10 of the present invention that bring the first swingarm sets closer together in the power drop zone side 68 of the rotational machine 10 and spread them apart in the lift zone side 70 of the machine 19, which together is one of the main objectives of the present invention, are set out below. By manipulating the different settings, the manufacturer can bring the first swingarm sets 50 closer together in the power drop zone side 68 of rotational machine 10 and spread them apart in the lift zone side 70, to a certain degree. However, by manipulating all the different settings in combination (conjunction) with each other is the most effective manner for grouping together and spreading apart the first swingarm sets 50 in the correct areas of rotational machine 10 for the greatest gravitational rotational power force at output shaft 14. These four settings are:

1. The extension distance ratio measurement of the horizontal extension of the center section 44 in the lift zone 70 side of the rotational machine 10 from the horizontal center of the first 40 and second 42 end sections of pivot bar 32 to a certain perimeter area point on rotational structure 94. The distance ratio measurement is in between the horizontal center of the first 40 and second 42 end sections of pivot bar 32 in a horizontal direction to a specific perimeter point on the rotational structure 94 in the lift zone 70 of the rotational machine 10. The specific perimeter point on the rotational structure 94 is to the center of the rods or bars 104 to the rotary connections of the second swingarm sets 98. By extending the center section 44 of pivot bar 32 out further toward the perimeter area of the rotational structure 94 in the lift zone 70 area of the rotational machine 10, it will cause the first swingarm sets 50 to come closer together in the drop zone 68 area of the rotational machine 10 and spread apart more in the lift zone 70 area.

2. The horizontal distance length of the first swingarm sets 50 from the center section 44 to its rotary connection 56 setting to the second swingarm set 98 is also a very important length and connection setting. This setting defines the rotary connection setting past the horizontal center of the first 40 and second 42 end sections of pivot bar 32 toward the power drop zone 68 side of the rotational machine 10. The closer the rotary connection setting toward the horizontal center line of the first 40 and second 42 end sections of pivot bar 32, the closer the first swingarm sets 50 are brought together in the power drop zone 68 side of the rotational machine 10 and the more they are spread out in the lift zone 70 side.

3. The length measurement of the first swingarm sets 50 from the center section 44 of pivot bar 32 to their rotary connections of the second swingarm sets 98 past the horizontal center of the first 40 and second 42 end sections of pivot bar 32 is a very important setting length. The further extended the center section 44 is toward the perimeter area of the rotational structure 94, the longer the first swingarm sets 50 are to their rotary connection settings with their second swingarm sets 98. The closer their horizontal rotary connections are to the horizontal center of the first 40 and second 42 end sections on the power drop 68 side of the rotational machine 10, the far closer the first swingarm sets 50 will be in the power drop zone 68 area of the rotational machine 10 and the far more spread apart they will be in the lift zone 70 area of the rotational machine 10. In combination with these settings and measurements, they work very well together in bringing together the first swingarm sets 50 in the power drop zone 68 area of the rotational machine 10 and spreading them apart in the lift zone 70 area.

4. The length and angle of the second swingarm sets 98 from its rotary connection to the rotational structure 94 to the rotary connection setting of the first swingarm set 50 in its horizontal position past the horizontal center line of the first 40 and second 42 end sections of pivot bar 32 is extremely important. The second swingarm bars 98 have to be in a pull down angle position from the rotational structure 94 to the first swingarm sets 50. The second swingarm sets 98 have to be set in such an angle that they pull downward in the power drop zone 68, to pull the rotational structure 94 downward from the gravitational weight of the greater number of first swingarm sets 50 in the power drop zone 68 side of the rotational machine 10. Likewise, the second swingarm sets 98 have to be in such an angle as to push upward on the first swingarm sets 50 in the lift zone 70 side of rotational machine 10 from rotational structures 94 that have the greater gravitational rotational force in them from the power drop zone 68 side of the rotational machine 10. Also, the second swingarm sets 98, by their length and setting to the rotary connections of the first swing arm sets 50, must bring the first swingarm sets 50 closer together in the power drop zone 68 side of the rotational machine 10 and spread them apart in the lift zone 70. Though, all the settings work best together.

The above four settings of the main working inner core parts to the rotational machine 10 are set after determining the diameter of the rotational structures 94, to the size of the rotational machine 10 for the amount of gravitational rotational power force that is necessary for rotational machine 10 to produce to power work machine 12.

The horizontal extension length measurement for the longitudinal axis of center section 44 from the longitudinal axis of the end sections 40/42 of pivot bar 32 (the distance center section 44 extends into the drop zone 68) is based on the ratio of the radius of the rotational structures 94 to the distance between the center of its rotary bearing connection 96 and the second swingarm sets 98. The greater this ratio, the greater the extension distance is for the center section 44 is in conjunction with the horizontal center axis position direction of the first swingarm sets 50 from its rotary connection 56 on the center section 44 to the rotary connection 96 on the other side of the end sections 40/42 or its second swingarm set 98 setting is from the longitudinal axis of the center section 44 (the closer to the longitudinal axis of end sections 40/42 through rotary connection 96 the better) the closer it will bring the first swingarm sets 50 together in the power drop zone 68 of the rotational machine 10 and the further apart they will be spread in the lift zone 70. The first swingarm sets 50 can be brought so close together in the power drop zone 68, that they will overlap each other (crossover one another). However, although it is best to get the first swingarm sets 50 as close together as possible, the crossover effect must be avoided as they will run into each other. Care must be used in setting the lengths, rotary connections and ratio settings of the main working inner core parts to the process of the rotational machine 10. The center section 44 for the first swingarm sets 50 doesn't have to be in a completely horizontal position from the end sections 40/42. Instead, it can be angled up or down from the horizontal position to improve the gravity rotational performance of rotational machine 10.

As set forth above, the angles of the second swingarm sets 98 and the distance to their first swingarm sets 50 to the rotational structure 94 is extremely important. The angles have to be set in such a position to the second set swingarm sets 98 that they pull down on the rotational structure 94, due to the weight members 60 on the first swingarm sets 50, in the power drop zone 68 of the rotational machine 10 and the angles to the second swingarm sets 98 from the rotational structure 94 to the first swingarm sets 50 have to be in a push up angle position in the lift zone 70, to push the first swingarm sets 50, with their weight members 60, up and around that side of rotational machine 10. The gravity powered drop force of the weight members 60 pulling down on the rotational structure 94 in the power drop zone 68 is greater than the weight of the weight members 60 on first swingarm sets 50 in the lift zone 70 due to the bunching of first swingarm sets 50 in the drop zone 68 (even without the benefit of the weight members 60 being extended outward on the first swingarm sets 50). Typically, the weight members 60 in the drop zone 68 is at least twice the amount in the lift zone 70. Because of this much greater gravitational power drop force on the rotational structure 94 in the power drop zone 68 of the rotational machine 10, from twice the number or more of the first swingarm sets 50 in the drop zone 68 within thirty degrees or less of the horizontal centerline of rotational machine 10 than in the lift zone 70, the rotational structure 94 will rotate with far more gravitational rotational power force than is necessary to turn, push, lift and rotate the far less amount of weight and number of first swingarm sets 50 in the lift zone 70. The greater number of weight members 60 in the power drop zone 68 of rotational machine 10 will transfer their gravitational power force to the rotational structures 94 through the use of the second swingarm sets 98. The portion of the rotational structure 94 in the lift zone 70 of the rotational machine 10 will transfer gravity rotational power force to the second swingarm sets 98 in the lift zone 70, which transfers the force to the far less number of first swingarm sets 50 in the lift zone 70 to push, lift and rotate them around the rotational machine 10. Because the rotational structures 94 have far more rotational power force than is needed to push, lift, and rotate the first swingarm sets 50 in the lift zone 70, this causes the rotational machine 10 to gain rotational speed and momentum, thereby providing gravity powered rotational force to turn output shaft 14 so as to operate work machine 12, such as an alternator, generators or other devices.

The far greater gravitational power force in the power drop zone 68 of the rotational machine 10 is always transferred to the rotational structures 94, which have a rotary bearing connection 96 to both first 40 and second 42 end sections of pivot bar 32. That is why the gears or pulleys 136 that are attached (with a solid connection) to the rotational structures 94 rotate.

In one configuration, having twelve first swingarm sets 50, the inventor was able to determine that eight of the first swingarm sets 50 would end up in the power drop zone 68 and only four of the first swingarm sets 50 would be in the lift zone 70 by adjusting the settings to the main working inner core of the gravity powered rotational machine 10. As a result of the gravitational rotational power force that the rotational machine 10 produces, it is very capable of turning a work machine 12, such as an alternators or generators for producing electricity or to operate other types of work machines. In fact, it is believed that rotational machine 10 can operate most equipment, just have to build it big enough.

The stationary channel bar railings 72 extend the weight members 60 outward tremendously on the first swingarm sets 50 in the power drop zone 68 and direct the weight members 60 all the way inward on the first swingarm sets 50 in the lift zone 70. A benefit of utilizing circular or oval channel bar railings 72 in an open side configuration is that there is space for the gear shafts or pulley shafts on both sides of the rotational machine 10 for connecting to the gears or pulleys of the driving mechanism 106 attached to the rotational structures 94. They are also open to the gear shafts or pulley shafts on both sides of the rotational machine 10 for the exterior braking mechanisms 130 that have a gear or pulley connection to the rotational structures 94 for stopping or slowing down rotational machine 10.

The center of the circular or oval stationary channel bar railings 72 are attached on the opposite side of the first 40 and second 42 end sections than the center section 44 on the center horizontal axis of the rotational machine 10 toward the power drop zone 68 side of the rotational machine 10. The stationary channel bar railings 72 are attached to both sides of the rotational machine 10. This creates an off-set from the center of the center section 44 that the first swingarm sets 50 rotate around on in the lift zone 68 of rotational machine 10, from the center of the channel bar railings 72 on the other side of rotational machine 10. Because channel bar railings 72 are centered on the other side of the first 40 and second 42 sections, this configuration is going to cause the weight members 60 on the first swingarm sets 50 to extend way into the power drop zone 68 and guide the weight members 60 inward on the first swingarm sets 50 in the lift zone 70 of the rotational machine 10.

The channel bar railings 72 are attached to their setting positions on both sides of rotational machine 10 by diagonal bracing members 84 and 86 to support frame 18 of the rotational machine 10. The diagonal bracing members 84 and 86 have structural crossmember bars 100 to hold the stationary channel bar railings 72 in their parallel positions to each other. The diagonal bracing members 72 are in diagonal angles to allow for the clearances of the output shaft 14 to work machine 12 and the gear shafts or pulley shafts 134 of the exterior braking mechanisms 130.

The weight leverage ratio, which is the amount of weight in the drop zone 68 versus the amount of weight in the lift zone, can be increased by providing a larger path 74 (as defined by channel bar railing 72) and increasing the length of the first swingarm sets 50, or by making a larger rotational machine 10 in general with a larger path 74. There is much that can be done to rotational machine 10 to increase the weight leverage ratio by increasing the weight in the power drop zone 68 and lessening the weight in the lift zone 70. This is accomplished by adjusting the relationship between various components to place more of the first swingarm sets 50 in the drop zone 68 than in the lift zone 70 at any given time.

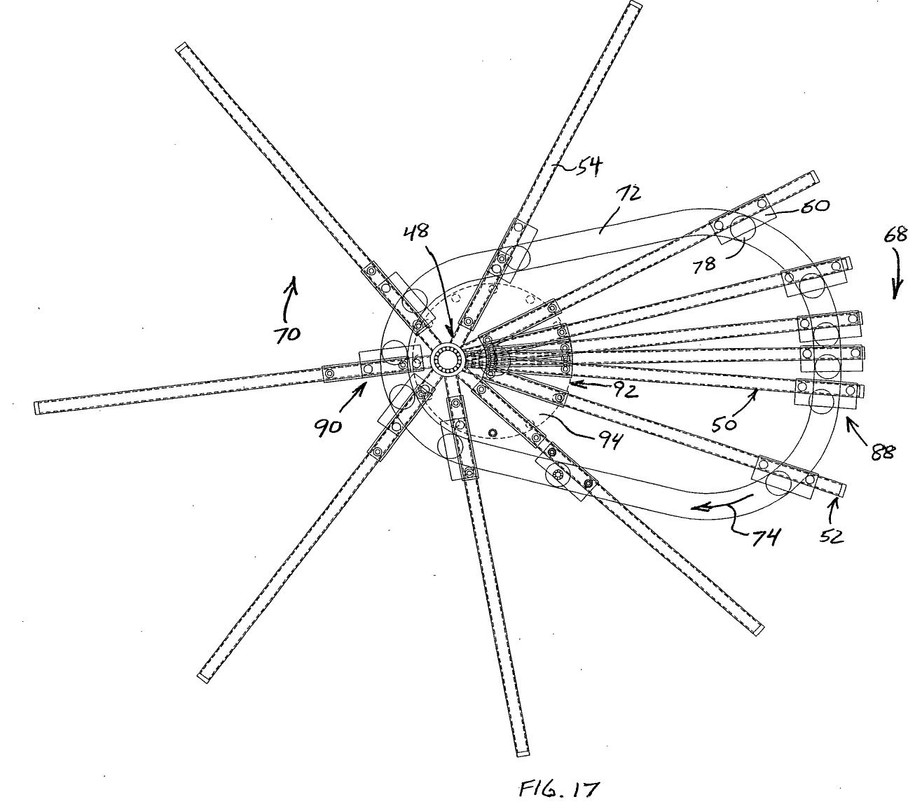

Examples of some of the modifications are shown in the schematics of FIGS. 19 through 22. In these figures, certain points and ratios of distances of settings create the grouping and spreading of the first swingarm sets 50 in the drop zone 68 and lift zone 70 of rotational machine 10. Point A is the center of the rotary connection of the curved second swingarm 100 of the second swingarm set 98 to the rotational structure 94. Point B is the opposite end of curved second swingarm 100, where the center of the rotary connection of the curved second swingarm 100 to the leverage railing arm 54 of the first swingarm set 50. Point C is the center of the longitudinal axis of first end section 40 (this would be the same for the second end section 42). Point D is the center of the longitudinal axis of center section 44. Length E is the extension offset of center section 44 into the lift zone 70, which is the distance between the longitudinal axis of the center section 44 to the center of end sections 40/42 (also the distance between points D and C). Length F is the distance between the longitudinal axis of end sections 40/42 and the center of the rotary connection of curved second swingarm 100 to leverage railing arm 54 (or distance between points C and B). Length G is the distance between the longitudinal axis of first end section 40 and the center of the rotary connection of the curved second swingarm 100 to the rotational structure 94. The extension ratio R1 is the ratio of length E to length G. The ratio R2 is the ratio of length F to length G.

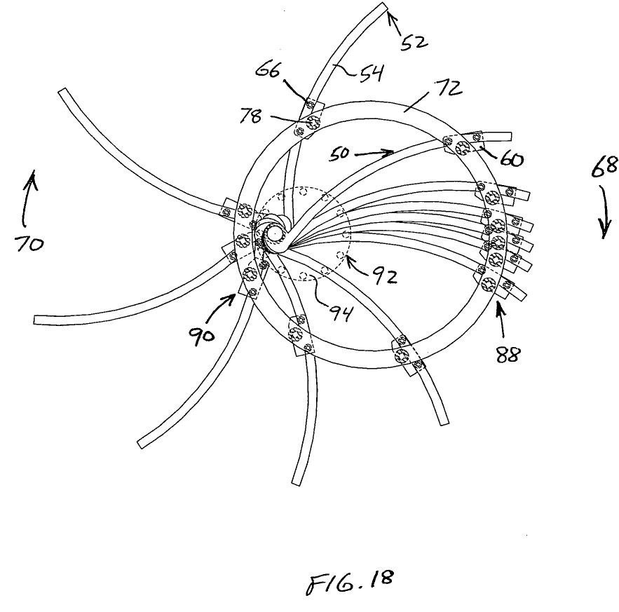

With regard to the schematics of FIGS. 19 through 22, the rotational machine 10 has twelve first swingarm sets 50, resulting in a spacing for the center of the rotary connection between the curved second swingarm 100 and rotational structure 94 (which is point A) around the rotational structure 94 of 30 degrees (i.e., 360 degrees divided by twelve). In FIG. 19, ratio R1 is selected to be 1/3 and R2 is selected to be 3/7. In FIG. 20, ratio R1 is selected to be 5/8 and R2 is selected to be held at 3/7 (same as FIG. 19). As can be seen, comparing FIG. 20 to FIG. 19, this results in a greater grouping of first swingarm sets 50 in the drop zone 68, more first swingarm sets 50 in the drop zone 68 and greater spreading of the first swingarm sets 50 in the lift zone 70. In FIG. 21, ratio R1 is selected to be 1/3 (the same as FIG. 19) and the ratio R2 is 1/28 (much closer than FIG. 19). As can be seen, there is greater grouping of the first swingarm sets 50 in the drop zone 68 and more spreading of first swingarm sets 50 in the lift zone 70 compared to FIG. 19. In FIG. 22, the ratio R1 is selected to be 5/8 (the same as FIG. 20) and the ratio B is selected to be 1/28 (the same as FIG. 21), which results in even more grouping of the first swingarm sets 50 in the drop zone 68 and more spreading of the first swingarm sets 50 in the lift zone 70 compared to FIGS. 20 and 21. While the closeness of the grouping of the first swingarm sets 50 in the drop zone 68 and spreading in the lift zone 70 results in better performance for rotational machine 10, it does require a much larger rotational machine 10 and/or much smaller weight members 60 due to the grouping being so close that the components could make contact with each other. In addition to the varied relationships between lengths and ratios set forth above, many more different combinations can be utilized to affect the performance of rotational machine 10. In addition, other components can also be varied or varied instead to alter the performance of rotational machine 10.

An important consideration with regard to selecting the various components and the relationship between components for rotational machine 10 is to end up with as many of the first swingarm sets 50 as possible in the area near the horizontal axis of the rotational machine 10 in the drop zone 68 and as few as possible in the lift zone 70. Because this area is where the greatest force is created and where the greatest lift would be needed, such configurations will improve the overall performance of rotational machine 10. In one embodiment, having twelve first swingarm sets 50, the inventor has been able to calculate that five of the first swingarm sets 50 would be within thirty degrees of the horizontal axis in the drop zone 68 and only one first swingarm sets 50 in the lift zone 70. As set forth above, a larger rotational machine 10 can provide more clearances and allow more of the first swingarm sets 50 to be grouped together, particularly in within thirty degrees of the horizontal axis, in the drop zone 68 and the grouping to be closer. In addition, the first swingarm sets 50 in the lift zone 70 will be more spread apart. Depending on how large the rotational machine 10 is, it is even possible to increase the ratio of the number of first swingarm sets 50 in the power drop zone 68 to the number of first swingarm sets 50 in the lift zone 70. In other words, the rotational machine 10 will have more first swingarm sets 50 in the power drop zone 68 and less in the lift zone 70. As a result, rotational machine 10 will have a far greater weight leverage ratio, which will cause the rotational machine 10 to have a greater gravity powered rotational force.

The better the grouping of the first swingarm sets 50 (the more of them and closer they are together) within thirty degrees of the horizontal center of rotational machine 10 the greater the gravitational force they will have in drop zone 68. This is particularly true within twenty degrees or less of the horizontal center of the rotational machine 10 in the power drop zone 68. The more spread out the first swingarm sets 50 are in the lift zone 70 of the rotational machine 10 the better. In addition, the further they are separated from the horizontal center of the rotational machine 10, the less gravitational force they have on the lift zone 70. This will also make it easier for the weight members 60 in the drop zone 68 side of the rotational machine 10 to lift and rotate the weight members 60 in the lift zone 70 side of the rotational machine 10. This results in the rotational machine 10 having a much greater rotational force and a greater amount of speed. The user can always put larger and heavier weight members 60 on the rotational machine 10 as well, to increase its gravitational rotational power force. If there is not much clearance for the weight members 60, and the user wants to bring the first swingarm sets 50 closer together in the power drop zone 68 of the rotational machine 10 without making the weight members 60 smaller or less heavy, but in fact want to the make the weight members 60 heavier, the user can make the rotational machine 10 wider. Doing this, allows the weight members 60 to be longer and heavier. Heavier and longer (wider) weight members 60 require the first swingarm sets 50 to be wider, the support frame 18 has to be wider, the housing 28 has to be wider, structural crossmembers have to be wider, and etc. Thus, the larger and heavier the weight members 60, the larger and heavier the rotational machine 10. Alternatively, the weight member 60 can be more slender for bringing the first swingarm sets 60 closer together in the drop zone 68 of the rotational machine 10.

### Operation of the Rotational Machine

Once movement of the rotational machine 10 is started, typically with energy input source 30 to power the initial rotation of one or both of the rotational structures 94, the first swingarm sets 50 begin to rotate around center section 44. Because the leverage railing arms 54 of the first swingarm sets 50 are rotatably connected, using rotating connectors 56, the various first swingarm sets 50 will rotate independent of each other around the stationary center section 44. The independent rotation allows the first swingarm sets 50 to group together or spread apart and rotationally slow down or speed up at times that are beneficial for the production of the rotational torque to be utilized by output shaft 14 to power work machine 12. As the first swingarm sets 50 rotate around the center section 44, weight members 60 move inward and outward on the leverage railing arms 54 of the first swingarm sets 50. In a preferred configuration, rail roller bearing wheel 66 or the like interconnect the weight members 60 to the leverage railing arms 54 so that the weight members 60 are substantially free to slide (i.e., by rail roller bearing wheels 66 rotating) along leverage railing arms 54. The inward and outward movement of weight members 60 is controlled by the use of an off-center path 74 around the center section 44 of pivot bar 32. The path 74 is defined, in the preferred embodiment, by a pair of spaced apart channel bar railings 72 and the weight members 60 connect to the channel bar railings 72 by the use of a weight crossmember bar 75 that extends from or passes through weight members 60. Interconnecting the weight crossmember bar 76 and the channel bar railings 72 are one or more channel roller bearings wheels 78, typically at the ends 80 and 82 of weight crossmember bar 76, that are cooperatively configured with channel bar railings 72 to move along the path 74. Because the path 74 is off-centered around center section 44, with the extended portion of path 74 forming a drop zone 68 and the narrow portion of path 74 forming the lift zone, the weight members 60 will be moved outward on leverage railing arms 54 to an extended torque position 88 in the drop zone 68 and then moved inward on leverage railing arms 54 to a reduced torque position 90 in the lift zone 70. In addition to the torque differential that is produced from the difference of the weight members 60 in their extended torque positions 88 versus being in their reduced torque positions 90, the first swingarm sets 50 and their weight members 60 are grouped together more in the drop zone 68 and spread apart more in the lift zone 70. This is partially achieved by the movement of the first swingarm sets 50 slowing down, in effect being geared down (although no gears are being utilized), in the drop zone 68 and then speeding up in the lift zone 70. As a result, there is always a constant supply of mass torque in the drop zone 68 of the machine and because the grouped leveraged weights are so geared down in the drop zone 68 that there is always a constant supply of mass gravitational torque in the drop zone 68.

Torque produced in the drop zone 68 by the weight members 60 of the relevant first swingarm sets 50 being generally in their extended torque position 88 is transferred to the first swingarm sets 50 in the lift zone 70 to move the first swingarm sets towards the top of the path 74 and then the drop zone 68. This torque transfer is accomplished by utilizing a force transfer mechanism 92 that comprises, in the preferred embodiment, a pair of rotational structures 94 that are rotationally mounted at the first 40 and second 42 end sections of pivot bar 32 and a plurality of second swingarm sets 98 to interconnect the leverage railing arms 54 of the first swingarm sets 50 to the rotational structures 94. The second swingarm sets 98 comprises a curved second swingarm 100 that is rotationally connected to the first swingarm sets 50 and rotational structures 94, typically by way of a first transfer crossmember 102 and a second transfer crossmember 104, respectively. The downward force of the weight members 60 in the drop zone 68 is transferred, in a pull down manner, through the leverage railing arms 54 to the second swingarm sets 98 and then to the rotational structure 94. The rotating rotational structure 94 transfers, in a push up manner, some of the rotational torque to the second swingarm sets 98 that are connected to first swingarm sets 50 that are in the lift zone 70 to move these first swingarm sets 50 through the lift zone 70. Because the weight members 60 of these first swingarm sets 50 will be in their reduced torque position 90, being disposed inward near the first end 48 of first swingarm sets 50, pushing them upward will take less force than is produced by the first swingarm sets 50 in the drop zone 68. This results in a net torque differential that is transferred to the output shaft 14 for use by work machine 12. In a preferred embodiment, the torque differential is transferred to the output shaft 14 by utilizing a driving mechanism 106 that comprises a first drive device 108 engaged with rotational structure 94, such as utilizing a collar sleeve 109, to rotate with rotational structure 94 around the first 40 and/or second 42 end sections of pivot bar 32. The first drive device 108 is cooperatively connected to a second drive device 114, such as by drive member 112, to rotate the second drive device 114, which is connected to and rotates output shaft 14 to provide rotational torque for work machine 12.

### Alternative Configurations

As stated above, the shape of path 74, defined by channel bar railings 72, can be generally circular, oval, egg-shaped, teardrop, uneven circular or oval or a variety of other shapes which positions the path 74 near center section 44 in the lift zone 70 than in the drop zone 68 so weight members 60 slide inward towards the first end 48 of first swingarm sets 50 as they move from the drop zone 68 to the lift zone 70. With the path 74 defined by the stationary channel bar railings 72 being off-set (i.e., extended far over) in the drop zone 68, this produces a tremendous leverage of the weight members 60 on the leverage railing arms 54 in drop zone 68. Path 74 can include configurations with more of a vertical arrangement to the portion of path 74 defining the drop zone 68 than the portion of path 74 defining the lift zone 70, which can be provided with same type of incline as described above. In this manner, more force can be obtained in the drop zone 68 due to a greater concentration without increasing the force necessary to lift the weight members 60 in the lift zone 70.

The use of an egg or pear shaped uneven oval path 74, having a steep vertical curvature in the drop zone 68, provides the weight members 60 on leverage railing arms 54 a far greater power drop distance in the drop zone 68 compared to the less vertical, broader drop of a full circle path 74. This steeper vertical distance of the weight members 60 in the drop zone 68 will produce a far greater gravitational power drop force in the drop zone 68 to increase the rotational torque produced by rotational machine 10. In addition, the far smaller circular cycle in the lift zone 70 pulls the weight members 60 in closer toward the pivot area, which in turn causes the weight members 60 to be lifted up and around much easier than compared to the much larger half circle cycle in a circular path 74. Also, the inclines to the exterior egg or pear shape uneven oval path 74 has far less uphill climb and distance for the weight members 60 to travel. This results in less force to push the weight members 60 up and around in the lift zone 70 and a large amount of the weight of weight members 60 is on the inclines to the railings of the egg or pear shape uneven oval path 74, compared to the full circular path 74 which has a far greater steeper incline. Because much of the weight is on the incline to the low angle railings, it will not take as much force to push them upward and around in the lift zone 70 and the distance for the weight members 60 to travel in the lift zone 70 is far less, making it much easier and faster for the weight members 60 in the drop zone 68 to spin them around. The steep vertical curvature of the half oval ellipse cycle in the drop zone 68 for the egg or pear shape path 74 can be extended outward quite some distance without changing the angle incline to the bar railing 72 and without changing the incline or angle direction positions of the weight members 60 in the lift zone 70. The further outward the steep half oval ellipse cycle is, the larger the steep vertical curvature will be in the drop zone 68. The greater this is, the greater the vertical travel drop distance is for the weight members 60, resulting in more gravitational force the concentrated weights will have in the drop zone 68. To accomplish this, the leverage railing arms will have to be lengthened to reach the channel bar railings 72 defining the path 74.

The different groups of moving connections of the parts to rotational machine 10 can comprise types of ball bearings, roller bearings, needle roller bearings, precision machined ball bearings, engineering bearing types (i.e., radial ball bearings, radial spherical roller bearings, radial cylindrical roller bearings, radial tapered roller bearings, thrust ball and roller bearings, etc.), magnetic bearings and any other type of bearing, bearing set up, or mechanism that makes the moving part function and perform the purpose as described above.

The different groups of rotary bearing wheel or ball connections to the parts of the gravity powered rotational machine can comprise various types of bearings, such as cam followers (standard or heavy stud), crowned cam followers (standard or heavy stud), cam-centric adjustable cam followers (cylindrical and crowned o.d.), yoke rollers (cylindrical and crowned o.d.), caged roller followers (with or without seals), mast guides and carriage rollers, chain sheaves and toothless sprockets, airframe track rollers and needle bearings, magnetic bearings, and any other type of bearing, bearing set up, or mechanism that functions and perform the purposes described above.

An additional, important consideration for the rotational machine 10 of the present invention, is that antifriction rotary, linear, circular, oval or etc. magnetic bearings can be used for the moving connections to the parts of the gravity powered rotational machine 10. Active magnetic bearings (AMBs) and self-sensing (sensorless) magnetic bearings can be used for all of the moving connections to the parts of the rotational machine 10. In this way, using the control system types of magnetic bearings for all of the connections to the moving parts of the rotational machine 10, and since they don't require lubrication, there wouldn't be any need for the housing 28 or the lubricating system 116, including the spray jets 118, hoses 120, reservoir 122, transfer pipes or hoses 124, pumps 126 and lubrication canal system 128.

In having these antifriction moving connections to the parts of the rotational machine 10, will cause the rotational machine 10 to have far less friction and drag on the moving connections to its parts. This will cause the rotational machine 10 to perform and rotate much smoother, faster, and to have more rotational power force. Rotational machine 10 can use these antifriction magnetic bearings on all or just some of the moving connections of the parts to reduce friction and drag.

The rotary, rolling or linear connections of the parts to the rotational machine 10 can have electrically charged magnetic bearing rotary, rolling or linear connections to the moving parts of the rotational machine 10. In having this, it will cause the rotational machine 10 to have less friction and drag to its rotary, rolling or linear connections to its parts, for it will keep the rotary, rolling or linear parts of rotational machine 10 from making contact with each other or touching each other as rotational machine 10 rotates around. This will cause rotational machine 10 to perform and rotate much smoother, faster and to have more rotational force. The electrically charged magnetic bearing rotary, rolling or linear connections to the rotary or linear connections to the parts of rotational machine 10 will be electrically charged by the electricity that the alternators or generators produce as they are turned by the gravitational rotational power force of rotational machine 10. Rotational machine 10 can have electrically charged large batteries that the alternators or generators attached to rotational machine 10 will keep electrically charged. The electricity from these highly electrically charged large batteries will engage (turn on) the electrically charged bearing rotary, rolling or linear connections to the rotary, rolling or linear connections to the parts of rotational machine 10 before braking mechanism 130 is disengaged from keeping rotational machine 10 from rotating. Once rotational machine 10 is rotating, then electricity for the electrically charged bearing rotary, rolling or linear parts connections are switched over from the batteries to receive some of the electricity that the alternators and/or generators are producing as a result of the gravitational rotational power force of rotational machine 10.

Another potential enhancement to improve the rotational torque performance of the rotational machine 10 is to make the leverage railing arms 54 of the first swingarm sets 50 curved in the direction of travel that weight members 60 are traveling, as shown in FIG. 18. The curved leverage railing arms 54 may cause the weight members 60 to roll inward and outward with far more ease as the first swingarm sets rotate around the center section 44 due to less drag and resistance to such movement. In addition, the weight members 60 may have more of a free flow travel throughout the rotational cycles of the first swingarm sets 50. This should cause the weight members 60 to move faster and produce more force in the drop zone 68 and with less torque required in the lift zone 70. Improving the inward and outward movement of the weight members 60 on the first swingarm sets will provide far greater gravity powered rotational force to turn output shaft 14 for operation of work machine 12, such as a generator or alternator to produce electricity.

While there are shown and described herein specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A gravity powered rotational machine, comprising:
a support frame;
a pivot bar supported by said support frame, said pivot bar having a first end section at a first end, a second end section at a second end and a center section interconnecting said first end section and said second end section;
a plurality of first swingarm sets rotatably attached at a first end to said pivot bar so as to rotate around said pivot bar, each of said first swingarm sets comprising a leverage railing arm and a weight member slidably engaged with said leverage railing arm, said weight member configured to move generally between said first end of said first swingarm sets and an outwardly extending second end of said first swingarm sets during the rotation of said first swingarm sets around said pivot bar;
one or more stationary railings defining a path around said pivot bar, said path having a drop zone and a lift zone, said stationary railing engaging each of said weight members so as to guide said weight members along said path and direct said weight members inwardly and outwardly on said first swingarm sets, said path configured to place said weight members in an extended torque position in said drop zone and in a reduced torque position in said lift zone;
force transfer means for transferring the rotational torque in said drop zone to said lift zone by cooperatively engaging each of said plurality of first swingarm sets; and
an output shaft operatively connected to said force transfer means so as to power a work machine connected thereto,
wherein during the operation of said gravity powered rotational machine said first swingarm sets in said drop zone have said weight members in the extended torque position while said first swingarm sets in said lift zone have said weight members in the reduced torque position to produce rotational torque that is transferred by said force transfer means from said drop zone to said lift zone and to said output shaft.

2. The gravity powered rotational machine according to claim 1, wherein said first end section and said second end section are axially aligned and said center section is axially offset to said first end section and said second end section.

3. The gravity powered rotational machine according to claim 2, wherein said first end section, said second end section and said center section are generally parallel.

4. The gravity powered rotational machine according to claim 1, wherein each of said first swingarm sets are rotatably attached to said center section of said pivot bar and configured to rotate independently of each other around said center section.

5. The gravity powered rotational machine according to claim 1, wherein each of said leverage railing arms has a rotating connector at said first end of said first swingarm sets.

6. The gravity powered rotational machine according to claim 5, wherein each of said first swingarm sets comprises a pair of said leverage railing arms.

7. The gravity powered rotational machine according to claim 6 further comprising at least one rail roller bearing wheel on each of a first side and a second side of said weight member, each of said roller bearing wheels rotatably engaging one of said pair of leverage railing arms of said first swingarm sets.

8. The gravity powered rotational machine according to claim 6 further comprising an end crossmember bar at said second end of said first swingarm sets that interconnects said pair of said leverage railing arms.

9. The gravity powered rotational machine according to claim 1, wherein said path is configured to be off-center around said center section.

10. The gravity powered rotational machine according to claim 1 further comprising a pair of said stationary railings defining said path and a weight crossmember bar engaged with each of said weight members to interconnect said pair of said stationary railings and dispose said weight members between said pair of stationary railings, said weight crossmember bar having a roller bearing wheel at each of a first end and a second end thereof that engage one of said pair of said stationary railings.

11. The gravity powered rotational machine according to claim 1, wherein said force transfer means comprises a rotational structure and a plurality of second swingarm sets, said rotational structure rotatably attached to said pivot bar, each of said second swingarm sets interconnecting said rotational structure and one of said first swingarm sets.

12. The gravity powered rotational machine according to claim 11, wherein said rotational structure is rotatably attached to one of said first end section and said second end section.

13. The gravity powered rotational machine according to claim 12, wherein said force transfer means comprises said rotational structure at each of said first end section and said second end section.

14. The gravity powered rotational machine according to claim 11, wherein said second swingarm sets comprise a second swingarm having a first end rotatably attached to said rotational structure and a second end rotatably attached to said leverage railing arm of said first swingarm sets.

15. The gravity powered rotational machine according to claim 1 further comprising driving means engaged with said force transfer means for rotatably driving said output shaft.

16. The gravity powered rotational machine according to claim 1, wherein said force transfer means is configured to generally group two or more of said first swingarm sets together in said drop zone and generally spread two or more of said first swingarm sets apart in said lift zone to increase the rotational torque in said drop zone relative to said lift zone.

17. The gravity powered rotational machine according to claim 1 further comprising a braking means for braking the rotational movement of said first swingarm sets.

18. The gravity powered rotational machine according to claim 1 further comprising a lubricating system configured to deliver lubricating fluid throughout said gravity powered rotational machine.

19. A gravity powered rotational machine, comprising:
a support frame;
an elongated pivot bar supported by said support frame, said pivot bar having a first end section at a first end, a second end section at a second end and a center section interconnecting said first end section and said second end section, said first end section and said second end section axially aligned, said center section axially offset and generally parallel to said first end section and said second end section;
a plurality of first swingarm sets rotatably attached at a first end to said center section of said pivot bar, each of said first swingarm sets configured to rotate independently of each other around said center section of said pivot bar, each of said first swingarm sets having a weight member slidably engaged on at least one leverage railing arm so as to move generally between said first end of said first swingarm sets and an outwardly extending second end of said first swingarm sets during the rotation of said first swingarm sets around said center section of said pivot bar;
one or more stationary railings defining an off-center path around said center section of said pivot bar, said path having a drop zone and a lift zone, said stationary railings configured to guide said weight member along said path and direct said weight members inwardly and outwardly on said first swingarm sets so as to place said weight members in an extended torque position in said drop zone and in a reduced torque position in said lift zone;
force transfer means for transferring the rotational torque in said drop zone to said lift zone by cooperatively engaging each of said plurality of first swingarm sets, said force transfer means comprising a rotational structure rotatably attached to at least one of said first end section and said second end section of said pivot bar and a plurality of second swingarm sets interconnecting said rotational structure and one of said leverage railing arms of said first swingarm sets; and
an output shaft operatively connected to said rotation structure so as to rotate said output shaft and power a work machine connected thereto,
wherein during the operation of said gravity powered rotational machine two or more of said first swingarm sets are grouped together in said drop zone with said weight members in the extended torque position while one or more of said first swingarm sets are spread apart in said lift zone with said weight members in the reduced torque position to produce rotational torque that is transferred by said rotational structure from said drop zone to said first swingarm sets in said lift zone and to said output shaft.

20. The gravity powered rotational machine according to claim 19, wherein each of said first swingarm sets comprises a pair of said leverage railing arms, each of said leverage railing arms having a rotating connector at said first end of said first swingarm sets, said weight member slidably engaged with each of said pair of leverage railing arms.

21. The gravity powered rotational machine according to claim 20 further comprising at least one rail roller bearing wheel on each of a first side and a second side of said weight member, each of said roller bearing wheels rotatably engaging one of said pair of said leverage railing arms.

22. The gravity powered rotational machine according to claim 19, wherein each of said second swingarm sets comprises a second swingarm having a first end rotatably attached to said rotational structure and a second end rotatably attached to said leverage railing arm.

23. The gravity powered rotational machine according to claim 19 further comprising driving means engaged with said rotational structure for rotatably driving said output shaft.

24. The gravity powered rotational machine according to claim 19, wherein said force transfer means is configured to generally group two or more of said first swingarm sets together in said drop zone and generally spread two or more of said first swingarm sets apart in said lift zone to increase the rotational torque in said drop zone relative to said lift zone.

25. A gravity powered rotational machine, comprising:
a support frame;
an elongated pivot bar supported by said support frame, said pivot bar having a first end section at a first end, a second end section at a second end and a center section interconnecting said first end section and said second end section, said first end section and said second end section axially aligned, said center section axially offset and generally parallel to said first end section and said second end section;
a plurality of first swingarm sets rotatably attached at a first end to said center section of said pivot bar, each of said first swingarm sets configured to rotate independently of each other around said center section of said pivot bar, each of said first swingarm sets comprising a pair of leverage railing arms having a rotating connector at said first end of said first swingarm sets, a weight member slidably engaged with each of said pair of leverage railing arms, and at least one rail roller bearing wheel on each of a first side and a second side of said weight member, each of said roller bearing wheels rotatably engaging one of said pair of leverage railing arms of said first swingarm sets to allow said weight members to move generally between said first end of said first swingarm sets and a second end of said first swingarm sets during the rotation of said first swingarm sets around said center section of said pivot bar;
a weight crossmember bar engaging each of said weight members, said weight crossmember bar having a channel roller bearing wheel at each of a first end and a second end thereof;
a pair of stationary railings defining an off-center path around said center section of said pivot bar, said path having a drop zone and a lift zone, one of said channel roller bearing wheels rotatably engaged with one of said stationary railings to guide said weight member along said path and direct said weight members inwardly and outwardly on said first swingarm sets, said path configured to place said weight members in an extended torque position in said drop zone and in a reduced torque position in said lift zone;
force transfer means for transferring the rotational torque in said drop zone to said lift zone by cooperatively engaging each of said plurality of first swingarm sets together, said force transferring means comprising a rotational structure rotatably attached to each of said first end section and said second end section of said pivot bar and a plurality of second swingarm sets interconnecting one of said rotational structure and one of said leverage railing arms of said first swingarm sets, said second swingarm sets comprising a second swingarm having a first end rotatably attached to said rotational structure and a second end rotatably attached to said leverage railing arm; and
driving means engaged with said rotational structure and rotatably supported on at least one of said first end section and said second end section of said pivot bar for rotatably driving an output shaft, said output shaft operatively connected to a work machine,
wherein during the operation of said gravity powered rotational machine a plurality of said first swingarm sets are grouped together in the drop zone with said weight members in the extended torque position while one or more of said first swingarm sets are spread apart in said lift zone with said weight members in the reduced torque position to produce rotational torque that is transferred by said rotational structure from said drop zone to said first swingarm sets in said lift zone and to said output shaft.

26. A method for rotating an output shaft of a gravity powered rotational machine for powering a work machine, said process comprising the steps of:
a) rotating a plurality of first swingarm sets around a center section of a pivot bar supported by a support frame, a first end of said first swingarm sets rotatably connected to said center section, said center section interconnecting a first end section at a first end of said pivot bar and a second end section at a second end of said pivot bar, said center section axially offset and generally parallel to said first end section and said second end section, each of said first swingarm sets comprising at least one leverage railing arm and a weight member slidably engaged therewith;
b) sliding said weight member between said first end of said first swingarm sets and an outwardly extending second end thereof as said first swingarm sets rotate around said center section of said pivot bar;
c) guiding the rotation of said swingarm sets around said center section while directing the movement of said weight members between said first end and said second end of said first swingarm sets on a path defined by one or more stationary railings attached to said support frame, said path having a drop zone with said weight members in an extended torque position and a lift zone with said weight members in a reduced torque position to produce rotational torque; and
d) transferring the rotational torque from said drop zone to said lift zone and to said output shaft by cooperatively engaging each of plurality of said first swingarm sets with a force transfer means rotatably attached to at least one of said first end section and said second end section.

27. The method according to claim 26, wherein each of said first swingarm sets comprises a pair of said leverage railing arms, each of said leverage railing arms having a rotating connector at said first end of said first swingarm sets.

28. The method according to claim 26 further comprising at least one rail roller bearing wheel on each of a first side and a second side of said weight member, each of said roller bearing wheels rotatably engaging one of said pair of leverage railing arms of said first swingarm sets.

29. The method according to claim 26, wherein said path is configured to be off-center around said center section.

30. The method according to claim 26, wherein a pair of said stationary railings define said path and a weight crossmember bar engages each of said weight members to interconnect said pair of said stationary railings and dispose said weight members between said pair of stationary railings, said weight crossmember bar having a roller bearing wheel at each of a first end and a second end thereof that each engage one of said pair of said stationary railings.

31. The method according to claim 26, wherein said force transfer means comprises a rotational structure and a plurality of second swingarm sets, said rotational structure rotatably attached to one of said first end section and said second end section, each of said second swingarm sets interconnecting said rotational structure and one of said first swingarm sets.

32. The method according to claim 31, wherein said force transfer means comprises said rotational structure at each of said first end section and said second end section.

33. The gravity powered rotational machine according to claim 31, wherein said second swingarm sets comprise a second swingarm having a first end rotatably attached to said rotational structure and a second end rotatably attached to said leverage railing arm of said first swingarm sets.

34. The method according to claim 26 further comprising driving means engaged with said force transfer means for rotatably driving said output shaft.

35. The method according to claim 26, wherein said force transfer means is configured to generally group two or more of said first swingarm sets together in said drop zone and generally spread two or more of said first swingarm sets apart in said lift zone to increase the rotational torque in said drop zone relative to said lift zone.
